(19) United States
(12) Patent Application Publication
(10) Pub. No.: US 2025/0068910 A1
(43) Pub. Date: Feb. 27, 2025

(54) METHODS AND SYSTEMS FOR GENERATING TASK AGNOSTIC REPRESENTATIONS

(71) Applicant: MASTERCARD INTERNATIONAL INCORPORATED, PURCHASE, NY (US)

(72) Inventors: Aakarsh Malhotra, New Delhi (IN); Akshay Sethi, New Delhi (IN); Sonia Gupta, Gurgaon (IN); Siddhartha Asthana, New Delhi (IN)

(21) Appl. No.: 18/455,518

(22) Filed: Aug. 24, 2023

(51) Int. Cl. G06N 3/084; G06N 3/0475

(52) U.S. Cl. CPC G06N 3/084; G06N 3/0475

(57) ABSTRACT

Methods and server systems for generating task-agnostic representations for nodes in bipartite graph are described herein. Method performed by server system includes accessing bipartite graph including first set of nodes and second set of nodes. Herein, set of edges exist between first and second set of nodes. Method includes performing for each node of first and second set of nodes: identifying a natural neighbor node, the natural neighbor node being a two-hop neighbor node from the each node, Then, generating temporary representation for one-hop neighbor node based on set of features corresponding to the one-hop neighbor node Then, generating temporary neighbor node based on temporary representation for the one-hop neighbor node. Then, generating augmented neighborhood based on the natural node and the temporary neighbor node, and then determining via machine learning model, task-agnostic representation for the each node based on augmented neighborhood.

### TECHNICAL FIELD

The present disclosure relates to artificial intelligence-based processing systems and, more particularly, to electronic methods and complex processing systems for generating a task-agnostic representation for each node in a bipartite graph.

### BACKGROUND

In the Artificial Intelligence (AI) or Machine Learning (ML) domain, various datasets can often be converted to bipartite graphs so that they can be analyzed to learn insights from the dataset thus, performing a task based on these insights. The term “Bipartite graph” refers to versatile graph structures that represent a relationship between two distinct types of nodes. It is noted that bipartite graphs have a wide range of applicability in real-world scenarios. For instance, in recommender systems, users and items can be defined as two types of nodes within a bipartite graph. In this instance, the edges between the distinct nodes within the bipartite graph will represent interactions between the users and items. Additionally, it should be noted that bipartite graphs possess unique structural features that set them apart from heterogeneous graphs. The term ‘heterogeneous graph’ refers to graph structures that represent a relationship between two different nodes of the same type. To that end, there are no direct connections between nodes of the same type in bipartite graphs, unlike homogeneous graphs.

In recent times, although various techniques have been developed in the field of graph embedding generation for homogeneous and heterogeneous graphs, developing meaningful representations for bipartite graphs remains a persistent challenge. In particular, such techniques must be optimized for modeling bipartite graphs, otherwise, the resulting node and graph embeddings turn out to be sub-optimal at best. It is noted that although a bipartite graph can be converted to a homogenous graph using transforming techniques, the same can lead to more problems such as the hubness problem. It should be understood that to address such issues, some approaches have been developed.

One such approach includes Self-Supervised Learning (SSL) algorithms for generating meaningful representations for bipartite graphs. As may be understood, since there is a general lack of labeled data for the nodes in bipartite graphs, an SSL-based model is also able to learn node embeddings in a manner that does not require the costly labeled data. However, as may be understood, the conventional SSL algorithms learn by performing a single pretext task or by training based on a single pretext task which makes the trained model or the representations learned from this SSL model, task-specific in nature. In other words, these models can only be trained for a specific downstream task. For instance, if an SSL model is trained by performing a single pretext task such as maximizing mutual information, even if the results for the bipartite graph representation learning are promising, the efficacy of task-specific representations thus learned for different downstream tasks and datasets is not satisfactory. For example, in the financial domain, if a cardholder-merchant bipartite graph is used to learn representations for each node (such as cardholder nodes or merchant nodes) using an SSL model with a pretext task such as detecting First Party Fraud (FPF), then the representations thus, learned would only be useful for detection of FPF for future payment transaction. On the other hand, the same representations would prove to be ineffective to perform other tasks such as determining third-party fraud, the likelihood of credit bursts, and so on.

Thus, there exists a technological need for technical solutions for learning or generating a task-agnostic representation for each node in a bipartite graph such that the task-agnostic representations show high efficacy when used to perform different downstream tasks.

### SUMMARY

Various embodiments of the present disclosure provide methods and systems for learning or generating a task-agnostic representation for each node in a bipartite graph.

In an embodiment, a computer-implemented method for generating a task-agnostic representation for each node in a bipartite graph is disclosed. The computer-implemented method performed by a server system includes accessing a bipartite graph from a database associated with the server system. The bipartite graph includes a first set of nodes and a second set of nodes. Herein, a set of edges exist between the first set of nodes and the second set of nodes. Each node of the first set of nodes and the second set of nodes corresponds to a set of features and each edge indicates information related to a relationship between two distinct nodes in the bipartite graph. The method includes performing for each node of the first set of nodes and the second set of nodes in the bipartite graph a set of steps. The set of steps includes identifying a natural neighbor node, the natural neighbor node being a two-hop neighbor node from the each node. Then, generating a temporary representation for a one-hop neighbor node based, at least in part, on the set of features corresponding to the one-hop neighbor node. Further, generating a temporary neighbor node based, at least in part, on the temporary representation for the one-hop neighbor node. Furthermore, generating an augmented neighborhood based, at least in part, on the natural node and the temporary neighbor node. Thereafter, determining via a machine learning model, a task-agnostic representation for the each node based, at least in part, on the augmented neighborhood.

In another embodiment, a server system is disclosed. The server system includes a communication interface and a memory including executable instructions. The server system also includes a processor communicably coupled to the memory. The processor is configured to execute the instructions to cause the server system, at least in part, to access a bipartite graph from a database associated with the server system. The bipartite graph includes a first set of nodes and a second set of nodes. Herein, a set of edges exist between the first set of nodes and the second set of nodes. Each node of the first set of nodes and the second set of nodes corresponds to a set of features and each edge indicates information related to a relationship between two distinct nodes in the bipartite graph. The system is further configured to perform for each node of the first set of nodes and the second set of nodes in the bipartite graph a set of steps. The set of steps performed by the server system includes identifying a natural neighbor node, the natural neighbor node being a two-hop neighbor node from the each node. Then, generating a temporary representation for a one-hop neighbor node based, at least in part, on the set of features corresponding to the one-hop neighbor node. Further, generating a temporary neighbor node based, at least in part, on the temporary representation for the one-hop neighbor node. Furthermore, generating an augmented neighborhood based, at least in part, on the natural node and the temporary neighbor node. Thereafter, determining via a machine learning model, a task-agnostic representation for the each node based, at least in part, on the augmented neighborhood.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a bipartite graph from a database associated with the server system. The bipartite graph includes a first set of nodes and a second set of nodes. Herein, a set of edges exist between the first set of nodes and the second set of nodes. Each node of the first set of nodes and the second set of nodes corresponds to a set of features and each edge indicates information related to a relationship between two distinct nodes in the bipartite graph. The method includes performing for each node of the first set of nodes and the second set of nodes in the bipartite graph a set of steps. The set of steps includes identifying a natural neighbor node, the natural neighbor node being a two-hop neighbor node from the each node. Then, generating a temporary representation for a one-hop neighbor node based, at least in part, on the set of features corresponding to the one-hop neighbor node. Further, generating a temporary neighbor node based, at least in part, on the temporary representation for the one-hop neighbor node. Furthermore, generating an augmented neighborhood based, at least in part, on the natural node and the temporary neighbor node. Thereafter, determining via a machine learning model, a task-agnostic representation for the each node based, at least in part, on the augmented neighborhood.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present technology, reference is now made to the following descriptions taken in connection with the accompanying drawings in which:

FIG. 1 illustrates an exemplary representation of an environment related to at least some example embodiments of the present disclosure;

FIG. 2 illustrates a simplified block diagram of a server system, in accordance with an embodiment of the present disclosure;

FIG. 3 illustrates an exemplary representation of a bipartite graph, in accordance with an embodiment of the present disclosure;

FIGS. 4A, 4B, and 4C, collectively, illustrate an architecture of the machine learning model, in accordance with an embodiment of the present disclosure;

FIG. 5 illustrates a process flow diagram depicting a method for generating a task-agnostic representation for each node of a bipartite graph, in accordance with an embodiment of the present disclosure;

FIG. 6 illustrates a process flow diagram depicting a method for training a machine learning model such as machine learning model, in accordance with an embodiment of the present disclosure;

FIG. 7 illustrates a simplified block diagram of an acquirer server, in accordance with an embodiment of the present disclosure, in accordance with an embodiment of the present disclosure;

FIG. 8 illustrates a simplified block diagram of an issuer server, in accordance with an embodiment of the present disclosure; and

FIG. 9 illustrates a simplified block diagram of a payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entirely hardware embodiment, an entirely software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

The terms “account holder”, “user”, “cardholder”, “consumer”, “buyer”, and “customer” are used interchangeably throughout the description and refer to a person who has a payment account or a payment card (e.g., credit card, debit card, etc.) associated with the payment account, that will be used by a merchant to perform a payment transaction. The payment account may be opened via an issuing bank or an issuer server.

The term “merchant”, used throughout the description generally refers to a seller, a retailer, a purchase location, an organization, or any other entity that is in the business of selling goods or providing services, and it can refer to either a single business location or a chain of business locations of the same entity.

The terms “payment network” and “card network” are used interchangeably throughout the description and refer to a network or collection of systems used for the transfer of funds through the use of cash substitutes. Payment networks may use a variety of different protocols and procedures in order to process the transfer of money for various types of transactions. Payment networks are companies that connect an issuing bank with an acquiring bank to facilitate online payment. Transactions that may be performed via a payment network may include product or service purchases, credit purchases, debit transactions, fund transfers, account withdrawals, etc. Payment networks may be configured to perform transactions via cash substitutes that may include payment cards, letters of credit, checks, financial accounts, etc. Examples of networks or systems configured to perform as payment networks include those operated by such as Mastercard®.

The term “payment card”, used throughout the description, refers to a physical or virtual card linked with a financial or payment account that may be presented to a merchant or any such facility to fund a financial transaction via the associated payment account. Examples of the payment card include, but are not limited to, debit cards, credit cards, prepaid cards, virtual payment numbers, virtual card numbers, forex cards, charge cards, e-wallet cards, and stored-value cards. A payment card may be a physical card that may be presented to the merchant for funding the payment. Alternatively, or additionally, the payment card may be embodied in the form of data stored in a user device, where the data is associated with a payment account such that the data can be used to process the financial transaction between the payment account and a merchant's financial account.

The term “payment account”, used throughout the description refers to a financial account that is used to fund a financial transaction. Examples of the financial account include, but are not limited to a savings account, a credit account, a checking account, and a virtual payment account. The financial account may be associated with an entity such as an individual person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The terms “payment transaction”, “financial transaction”, “event”, and “transaction” are used interchangeably throughout the description and refer to a transaction of payment of a certain amount being initiated by the cardholder. More specifically, refers to electronic financial transactions including, for example, online payment, payment at a terminal (e.g., Point Of Sale (POS) terminal), and the like. Generally, a payment transaction is performed between two entities, such as a buyer and a seller. It is to be noted that a payment transaction is followed by a payment transfer of a transaction amount (i.e., monetary value) from one entity (e.g., issuing bank associated with the buyer) to another entity (e.g., acquiring bank associated with the seller), in exchange of any goods or services.

### Overview

Various embodiments of the present disclosure provide methods, systems, user devices, and computer program products for generating a task-agnostic representation for each node in a bipartite graph.

In an embodiment, the server system is configured to access a bipartite graph from a database associated with the server system. In various non-limiting examples, the bipartite graph may include a first set of nodes and a second set of nodes such that a set of edges exist between the first set of nodes and the second set of nodes. It is understood that each node of the first set of nodes and the second set of nodes corresponds to a set of features and each edge indicates information related to a relationship between two distinct nodes in the bipartite graph. In an implementation, the server system may be responsible for generating the bipartite graph. For generating the bipartite graph the server system is configured to at first, access a relational dataset from the database. In an example, the relational dataset may include information related to a plurality of first entities, a plurality of second entities, and a relationship between the plurality of first entities and the plurality of second entities. Then, the server system is configured to generate a first set of features for each of the plurality of first entities and a second set of features for each of the plurality of second entities based, at least in part, on the relational dataset. Thereafter, the server system is configured to generate the bipartite graph based, at least in part, on the relational dataset, the first set of features, and the second set of features. It is noted that the bipartite graph includes the first set of nodes corresponding to the plurality of first entities and the second set of nodes corresponding to the plurality of second entities. Herein, each of the first set of nodes and each of the second set of nodes of the bipartite graph is connected by an edge. In various non-limiting examples, the plurality of first entities may include at least one of a plurality of cardholders and a plurality of issuers. Similarly, in various non-limiting examples, the plurality of second entities is at least one of a plurality of merchants and a plurality of acquirers.

In another embodiment, the server system is configured to perform for each node of the first set of nodes and the second set of nodes in the bipartite graph a set of operations. The set of operations may include (1) identifying a natural neighbor node, the natural neighbor node being a two-hop neighbor node from the each node, (2) generating a temporary representation for a one-hop neighbor node based, at least in part, on the set of features corresponding to the one-hop neighbor node. (3) generating a temporary neighbor node based, at least in part, on the temporary representation for the one-hop neighbor node, (4) generating an augmented neighborhood based, at least in part, on the natural node and the temporary neighbor node, and (5) determining via a machine learning model, a task-agnostic representation for the each node based, at least in part, on the augmented neighborhood. In a non-limiting example, the machine learning model is a Multi-Task Bipartite Graph Neural Network (MultiBipGNN) based machine learning model.

As may be understood, the server system may also initialize and train the machine learning model used to determine the task-agnostic representations. To that end, in an embodiment, the server system is configured to train the machine learning model based, at least in part, on performing a set of operations iteratively till the performance of the machine learning model converges to a predefined criteria. This set of operations may include (1) initializing the machine learning model based, at least in part, on one or more model parameters. Herein, the machine learning model may include a set of shared layers and a set of task-specific layers. (2) Processing via the machine learning model, the bipartite graph by performing a set of tasks to compute a set of outputs. Herein, the set of tasks may include a set of generative tasks and a set of entropy-based tasks. (3) generating a task-specific loss corresponding to each task of the set of generative tasks and the set of entropy-based tasks based, at least in part, on the set of outputs and the relational dataset, and (4) optimizing the one or more model parameters based, at least in part, on back-propagating the task-specific loss corresponding to each task of the set of generative tasks and the set of entropy-based tasks.

In one scenario, processing the bipartite graph by performing the set of tasks may further include processing via the machine learning model, the bipartite graph by performing the set of generative tasks. The set of generative tasks includes at least a feature reconstruction task. Then, masking a subset of features from the set of features corresponding to each node of a subset of nodes of the bipartite graph. Thereafter, predicting via the machine learning model, the subset of features corresponding to the each node based, at least in part, on the remaining features from the set of features corresponding to the each node. Further, computing a feature reconstruction loss for the subset of nodes based, at least in part, on the predicted subset of features and the subset of features. It is noted that the feature reconstruction loss is the task-specific loss corresponding to the feature reconstruction task of the set of generative tasks. Furthermore, fine-tuning the one or more model parameters based, at least in part, on back-propagating the feature reconstruction loss.

In another scenario, processing the bipartite graph by performing the set of tasks may further include processing via the machine learning model, the bipartite graph by performing the set of generative tasks. The set of generative tasks includes at least a topological reconstruction task. Then, masking a subset of edges from the set of edges associated with a subset of nodes of the bipartite graph. Thereafter, predicting via the machine learning model, the subset of edges associated with a subset of nodes of the bipartite graph based, at least in part, on the remaining edges from the set of edges. Further, computing a topological reconstruction loss for the subset of nodes based, at least in part, on the predicted subset of edges and the subset of edges. It is noted that the topological reconstruction loss is the task-specific loss corresponding to the topological reconstruction task of the set of generative tasks. Furthermore, fine-tuning the one or more model parameters based, at least in part, on back-propagating the topological reconstruction loss.

In yet another scenario, processing the bipartite graph by performing the set of tasks may further include processing via the machine learning model, the bipartite graph by performing the set of entropy-based tasks. The set of entropy-based tasks includes at least a contrastive learning task. Then, computing via the machine learning model, an actual representation for the each node based, at least in part, on the set of features corresponding to the each node. Further, generating a neighbor node representation for the one-hop neighbor node of each node of a subset of nodes of the bipartite graph based, at least in part, on the set of features corresponding to the one-hop neighbor node. Furthermore, predicting via the machine learning model, a predicted representation for the each node based, at least in part, on the neighbor node representation, Thereafter, computing a contrastive loss for the each node based, at least in part, on the predicted representation and the actual representation. It is noted that contrastive loss is the task-specific loss corresponding to the contrastive learning task of the set of entropy-based tasks. Finally, fine-tuning the one or more model parameters based, at least in part, on back-propagating the contrastive loss.

In yet another scenario, processing the bipartite graph by performing the set of tasks may further include processing via the machine learning model, the bipartite graph by performing the set of entropy-based tasks. The set of entropy-based tasks includes at least a mutual information maximization for edge-graph task. Then, computing via the machine learning model, an edge representation for an edge of the set of edges based, at least in part, on the information related to a relationship between two distinct nodes connected by the edge. Further, computing via the machine learning model, a graph representation for the bipartite graph based, at least in part, on the set of features corresponding to each node of the bipartite graph. Furthermore, computing an edge-graph loss for the edge based, at least in part, on the edge representation and the graph representation. It is noted that the edge-graph loss is the task-specific loss corresponding to the mutual information maximization for edge-graph task of the set of entropy-based tasks. Thereafter, fine-tuning the one or more model parameters based, at least in part, on back-propagating the edge-graph loss.

In yet another scenario, processing the bipartite graph by performing the set of tasks may further include processing via the machine learning model, the bipartite graph by performing the set of entropy-based tasks. The set of entropy-based tasks includes at least a mutual information maximization for sub-graph-graph task. Then, extracting a sub-graph from the bipartite graph based, at least in part, on a predefined set of rules. Further, computing via the machine learning model, a sub-graph representation for the sub-graph based, at least in part, on the set of features corresponding to each node of the sub-graph, Furthermore, computing via the machine learning model, a graph representation for the bipartite graph based, at least in part, on the set of features corresponding to each node of the bipartite graph, Thereafter, computing a sub-graph-graph loss for the sub-graph based, at least in part, on the sub-graph representation and the graph representation. It is noted that the sub-graph-graph loss is the task-specific loss corresponding to the mutual information maximization for sub-graph-graph task of the set of entropy-based tasks. Finally, fine-tuning the one or more model parameters based, at least in part, on back-propagating the sub-graph-graph loss.

In another embodiment, the training process of the machine learning model described above may further include computing a task-specific activation probability for each task of the set of tasks. Then, performing one of (1) scheduling one or more tasks from the set of tasks to activate based, at least in part, on the task-specific activation probability computed for the corresponding task being lower than a predefined threshold, or (2) scheduling the one or more tasks from the set of tasks to deactivate based, at least in part, on the task-specific activation probability computed for the corresponding task being at least equal to the predefined threshold.

Various embodiments of the present disclosure provide multiple advantages and technical effects while addressing technical problems such as how to generate a task-agnostic representation for each node in a bipartite graph. To that end, the various embodiments of the present disclosure provide an approach for generating a task-agnostic representation for each node in a bipartite graph. As described herein, the server system is configured to generate an augmented neighborhood for each node and then, learn or determine a task-agnostic representation for that node using a machine learning model (i.e., a Multi-Task Bipartite Graph Neural Network (GNN) based machine learning model). As may be understood, the augmented neighborhood enables the machine learning model to learn from aggregated information from two-hop nodes (i.e., nodes of the same type) and one-hop nodes (i.e., nodes of different or distinct types). This aspect improves the performance of the machine learning model since now the model can learn from more information than conventionally possible. It is noted that conventional approaches are only able to learn information from two-hop nodes (or same-type nodes). To that end, the learning performance of the approach described in the present disclosure is higher. Further, the Multi-Task Bipartite Graph Neural Network (MultiBipGNN) based machine learning model can utilize a set of tasks (or pretext tasks) for improving the overall generalization of the learning for the model. Further, the MultiBipGNN model is a multi-task SSL algorithm that learns in a self-supervised manner by performing a set of tasks.

Furthermore, the MultiBipGNN model is also able to dynamically schedule one or more tasks from the set of tasks to be activated or deactivated during the learning or training process, which improves the overall learning of the model during the Multi-Task Leaning process while reducing the phenomenon of negative transfer between different tasks during the learning or training process. This aspect of the MultiBipGNN model also improves the performance of the model while generating a task-agnostic representation for each node of the bipartite graph. Furthermore, the approach of the present disclosure provides task-agnostic representations that can be used to perform various downstream tasks therefore, the present approach has a high scalability and displays fast adaptations for any downstream task. Additionally, the approach of the present disclosure requires fewer labels for its operation therefore, it has a wider applicability in real-life tasks that generally lack properly labeled data.

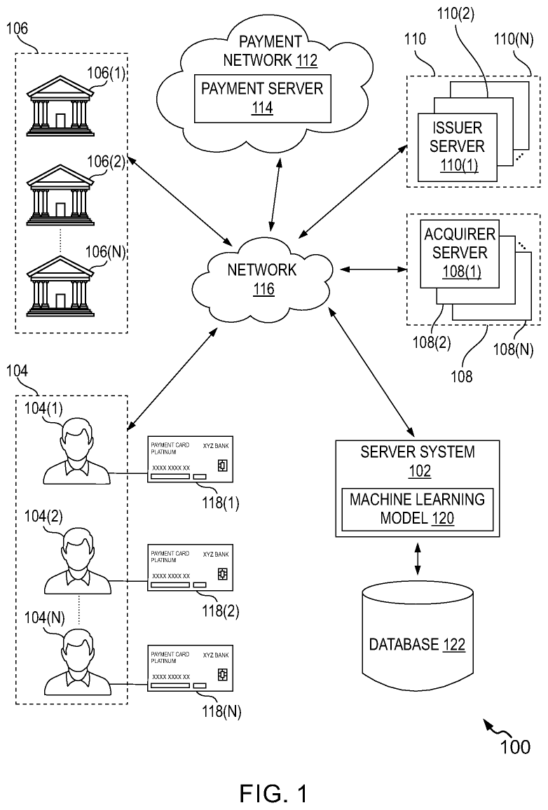

Various embodiments of the present disclosure are described hereinafter with reference to FIGS. 1 to 9.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, generating task-agnostic representations for each node in a bipartite graph including a plurality of nodes, training a machine learning model by performing a set of tasks, scheduling one or more tasks from a set of tasks to activate or deactivate while training the machine learning model and the like.

The environment 100 generally includes a plurality of components such as a server system 102, a database associated with the server system, a payment network 112 including a payment server 114 and a plurality of entities such as a plurality of cardholders 104(1), 104(2), . . . 104(N) (collectively, referred to as a plurality of cardholders 104 and ‘N’ is a Natural number), a plurality of merchants 106(1), 106(2), . . . 106(N) (collectively, referred to as a plurality of merchants 106 and ‘N’ is a Natural number), a plurality of acquirers 108(1), 108(2), . . . 108(N) (collectively, referred to as a plurality of acquirers 108 and ‘N’ is a Natural number), a plurality of issuers 110(1), 110(2), . . . 110(N) (collectively, referred to as a plurality of issuers 110 and ‘N’ is a Natural number), and a payment network 112 including a payment server 114, each coupled to, and in communication with (and/or with access to) a network 116. It is noted that the plurality of entities may further be classified into a plurality of first entities and a plurality of second entities. In particular, this classification may be done based on the type of entity. For instance, the plurality of first entities may include at least one of a plurality of cardholders 104, and a plurality of issuers 110. On the other hand, the plurality of second entities is at least one of a plurality of merchants 106 and a plurality of acquirers 108. It is noted that these entities may be classified or segregated based, at least in part, on their relationship in the payment network with each other in the payment ecosystem. The network 116 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an Infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 116 in accordance with various wired and wireless communication protocols, such as Transmission Control Protocol/Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 116 may include multiple different networks, such as a private network made accessible by the server system 102 and a public network (e.g., the Internet, etc.) through which the server system 102, the plurality of acquirer servers 108, the plurality of issuer servers 110, and the payment server 114 may communicate.

In an embodiment, the plurality of cardholders 104 use one or more payment cards 118(1), 118(2), . . . 118(N) (collectively, referred to hereinafter as a plurality of payment cards 118 and ‘N’ is a Natural number) respectively to make payment transactions at the plurality of merchants 106. The cardholder (e.g., the cardholder 104(1)) may be any individual, representative of a corporate entity, a non-profit organization, or any other person that is presenting payment account details during an electronic payment transaction with a merchant (e.g., the merchant 106(1)). The cardholder (e.g., the cardholder 104(1)) may have a payment account issued by an issuing bank (not shown in figures) associated with an issuer server (e.g., issuer server 110(1)) from the plurality of the issuer servers 110(explained later) and may be provided a payment card (e.g., the payment card 118(1)) with financial or other account information encoded onto the payment card (e.g., the payment card 118(1)) such that the cardholder (i.e., the cardholder 104(1)) may use the payment card 118(1) to initiate and complete a payment transaction using a bank account at the issuing bank.

In an example, the plurality of cardholders 104 may use their corresponding electronic devices (not shown in figures) to access a mobile application or a website associated with the issuing bank, or any third-party payment application. In various non-limiting examples, electronic devices may refer to any electronic devices such as, but not limited to, Personal Computers (PCs), tablet devices, Personal Digital Assistants (PDAs), voice-activated assistants, Virtual Reality (VR) devices, smartphones, and laptops.

In an embodiment, the plurality of merchants 106 may include retail shops, restaurants, supermarkets or establishments, government and/or private agencies, or any such places equipped with POS terminals, where customers such as the plurality of cardholders 104 visit for performing the financial transaction in exchange for any goods and/or services or any financial transactions.

In one scenario, the plurality of cardholders 104 may use their corresponding payment accounts or payment cards (e.g., the plurality of payment cards 118) to conduct payment transactions with the plurality of merchants 106. Moreover, it may be noted that each of the plurality of cardholders 104 may use their corresponding payment card from the plurality of payment cards 118 differently or make the payment transaction using different means of payment. For instance, the cardholder 104(1) may enter payment account details on an electronic device (not shown) associated with the cardholder 104(1) to perform an online payment transaction. In another example, the cardholder 104(2) may utilize the payment card 118(2) to perform an offline payment transaction. It is understood that generally, the term “payment transaction” refers to an agreement that is carried out between a buyer and a seller to exchange goods or services in exchange for assets in the form of a payment (e.g., cash, fiat-currency, digital asset, cryptographic currency, coins, tokens, etc.). For example, the cardholder 104(3) may enter details of the payment card 118(3) to transfer funds in the form of fiat currency on an e-commerce platform to buy goods. In another instance, each cardholder (e.g., the cardholder 104(1)) of the plurality of cardholders 104 may transact at any merchant (e.g., the merchant 106(1)) from the plurality of merchants 106.

In one embodiment, the plurality of cardholders 104 is associated with the plurality of issuer servers 110. In one embodiment, an issuer server such as issuer server 110(1) is associated with a financial institution normally called an “issuer bank”, “issuing bank” or simply “issuer”, in which a cardholder (e.g., the cardholder 104a) may have the payment account, (which also issues a payment card, such as a credit card or a debit card), and provides microfinance banking services (e.g., payment transaction using credit/debit cards) for processing electronic payment transactions, to the cardholder (e.g., the cardholder 104(1)).

In an embodiment, the plurality of merchants 106 is associated with the plurality of acquirer servers 108. In an embodiment, each merchant (e.g., the merchant 106(1)) is associated with an acquirer server (e.g., the acquirer server 108(1)). In one embodiment, the acquirer server 108(1) is associated with a financial institution (e.g., a bank) that processes financial transactions for the merchant 106(1). This can be an institution that facilitates the processing of payment transactions for physical stores, merchants (e.g., the merchants 106), or institutions that own platforms that make either online purchases or purchases made via software applications possible (e.g., shopping cart platform providers and in-app payment processing providers). The terms “acquirer”, “acquiring bank”, “acquiring bank” or “acquirer server” will be used interchangeably herein.

As explained earlier, it is desirable to generate meaningful representations for bipartite graphs however, the conventional SSL-based algorithms are unable to generate task-agnostic representations or embeddings for the plurality of nodes in the bipartite graph. As described earlier, the conventional SSL algorithms learn by performing a single pretext task or by training based on a single pretext task which makes the trained model or the representations learned from this SSL model, task-specific in nature. In other words, these models can only be trained for a specific downstream task. For instance, if an SSL model is trained by performing a single pretext task such as maximizing mutual information, even if the results for the bipartite graph representation learning are promising, the efficacy of task-specific representations thus learned for different downstream tasks and datasets is not satisfactory. For example, in the financial domain, if a cardholder-merchant bipartite graph is used to learn representations for each node (such as cardholder nodes or merchant nodes) using an SSL model with a pretext task such as detecting First Party Fraud (FPF), then the representations thus, learned would only be useful for detection of FPF for future payment transaction. On the other hand, the same representations would prove to be ineffective in performing other tasks such as determining third-party fraud, the likelihood of credit bursts, and so on.

The above-mentioned technical problem among other problems is addressed by one or more embodiments implemented by the server system 102 of the present disclosure. In one embodiment, the server system 102 is configured to perform one or more of the operations described herein.

In one embodiment, the environment 100 may further include a database 122 coupled with the server system 102. In an example, the server system 102 coupled with the database 122 is embodied within the payment server 114, however, in other examples, the server system 102 can be a standalone component (acting as a hub) connected to any of the plurality of acquirer servers 108 and any of the plurality of issuer servers 110. The database 122 may be incorporated in the server system 102 or maybe an individual entity connected to the server system 102 or maybe a database stored in cloud storage. In one embodiment, the database 122 may store a machine learning model 120, a relational dataset, and other necessary machine instructions required for implementing the various functionalities of the server system 102 such as firmware data, operating system, and the like. In a particular non-limiting instance, the server system 102 may locally store the machine learning model 120 as well (as depicted in FIG. 1).

In an example, the database 122 stores the relational dataset that includes information related to a plurality of first entities, a plurality of second entities, and a relationship between the plurality of first entities and the plurality of second entities. For instance, in the financial domain, the relational dataset may be a historical transaction dataset. In this scenario, the relational dataset includes real-time transaction data of the plurality of cardholders 104 and the plurality of merchants 106. To that end, the transaction data may also be called merchant-cardholder interaction data. The transaction data may include, but is not limited to, transaction attributes, such as transaction amount, source of funds such as bank or credit cards, transaction channel used for loading funds such as POS terminal or ATM, transaction velocity features such as count and transaction amount sent in the past ‘x’ number of days to a particular user, transaction location information, external data sources, merchant country, merchant Identifier (ID), cardholder ID, cardholder product, cardholder Permanent Account Number (PAN), MCC, merchant location data or merchant co-ordinates, merchant industry, merchant super industry, ticket price, and other transaction-related data.

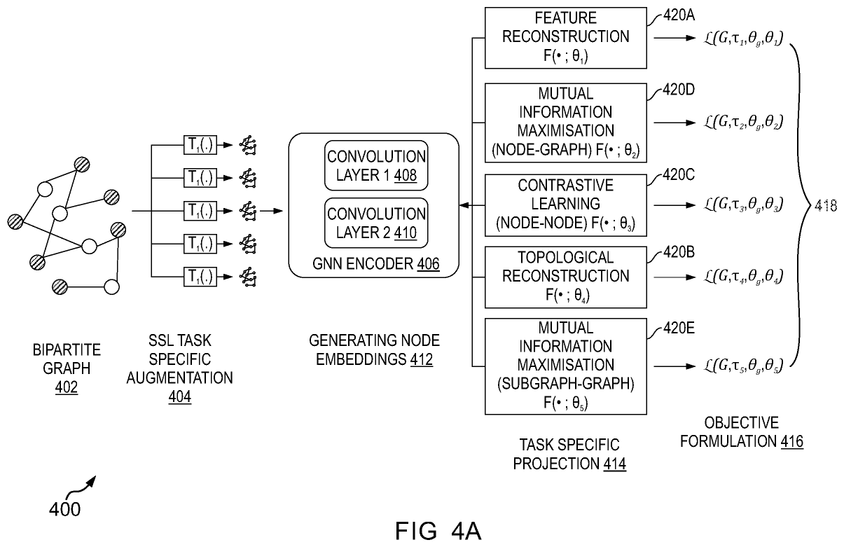

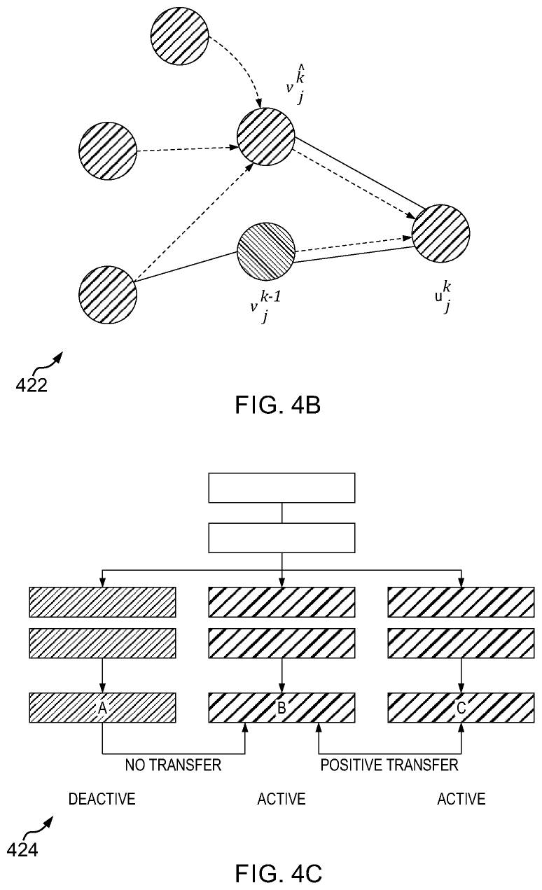

In another example, the machine learning model 120 may be an AI or an ML based models that is configured or trained to perform a plurality of operations. In a non-limiting example, the machine learning model 120 is a Multi-Task Bipartite Graph Neural Network (GNN) based machine learning model. It is noted that the models have been explained in detail later in the present disclosure with reference to FIGS. 4A-C. In addition, the database 122 provides a storage location for data and/or metadata obtained from various operations performed by the server system 102.

In an embodiment, the server system 102 is configured to access the relational dataset from the database 122 associated with the server system 102. As described earlier, the relational dataset may include information related to a plurality of first entities, a plurality of second entities, and a relationship between the plurality of first entities and the plurality of second entities. For instance, in the financial domain, the plurality of first entities may be the plurality of cardholders 104 and the plurality of second entities may be the plurality of merchants 106. In another embodiment, the server system 102 is configured to generate a first set of features for each of the plurality of first entities. Further, the server system is configured to generate a second set of features for each of the plurality of second entities based, at least in part, on the relational dataset. For example, a set of cardholder related features may be generated for each cardholder from the plurality of cardholders 104. Similarly, a set of merchant related features may be generated for each merchant from the plurality of merchants 106. It is noted that the relational data may include various data points that may be used to create features using conventional techniques. It is noted that in the present disclosure, the process of transforming the various data points in the relational dataset into features can be performed using conventional or known techniques and therefore, the same is not explained herein for the sake of brevity.

In another embodiment, the server system 102 is configured to generate a bipartite graph based, at least in part, on the relational dataset, the first set of features, and the second set of features. In various non-limiting examples, the bipartite graph may include a first set of nodes corresponding to the plurality of first entities and a second set of nodes corresponding to the plurality of second entities. It is noted that each node of the first set of nodes and each of the second set of nodes is connected by an edge. In other words, a set of edges exist between the first set of nodes and the second set of nodes. More specifically, each node of the first set of nodes and the second set of nodes correspond to the set of features. Further, each edge of the set of edges may indicate information related to a relationship between two distinct nodes in the bipartite graph. Herein, the distant nodes refer to the first set of nodes and the second set of nodes. For example, in the financial domain, the bipartite graph may be generated for the plurality of cardholders 104 and the plurality of merchants 106. In this example, the bipartite graph may be called a cardholder-merchant bipartite graph or merchant-cardholder bipartite graph. Further, the first set of nodes may be the plurality of cardholders 104 and the second set of nodes may be the plurality of merchants 106. In another example, the bipartite graph may be generated for the plurality of acquirers 108 and the plurality of issuers 110. In this example, the bipartite graph may be called an acquirer-issuer bipartite graph or an issuer-acquirer bipartite graph. Further, the first set of nodes may be the plurality of acquirers 108 and the second set of nodes may be the plurality of issuers 110. Upon generation of the bipartite graph, the bipartite graph may be stored in the database 122 associated with the server system 102. It is noted that when the server system 102 has to determine task-agnostic representations for the plurality of nodes in the bipartite graph, the server system 102 may access the bipartite graph from the database 122. In a situation, where the bipartite graph is not available, the server system 102 may generate the bipartite graph based on the process described earlier.

In another embodiment, the server system 102 is configured to perform a set of steps for each node of the first set of nodes and the second set of nodes in the bipartite graph to determine its corresponding task-agnostic representation (or embedding). At first, the server system is configured to identify a neighbor node of a particular node (i.e., the node for which the task-agnostic representation has to be determined). Herein, the natural neighbor node is a two-hop neighbor node from this particular node. Then, the server system 102 generates a temporary representation for a one-hop neighbor node of this particular node based, at least in part, on the set of features corresponding to the one-hop neighbor node. Further, the server system 102 generates a temporary neighbor node based, at least in part, on the temporary representation of the one-hop neighbor node of this particular node. Then, the server system 102 generates an augmented neighborhood for this particular node based, at least in part, on the natural node and the temporary neighbor node. It is noted that these aspects of the present disclosure have been described in detail with reference to FIG. 4B in the present disclosure. Thereafter, the server system 102 determines a task-agnostic representation for this particular node based, at least in part, on the augmented neighborhood. More specifically, the machine learning model 120 may be utilized by the server system 102 to determine the task-agnostic representation for the particular node based, at least in part, on the augmented neighborhood. In a non-limiting example, the machine learning model 120 may be a Multi-Task Bipartite Graph Neural Network (MultiBipGNN) based machine learning model.

As may be understood, the augmented neighborhood enables the machine learning model 120 to learn from aggregated information from two-hop nodes (i.e., nodes of the same type) and one-hop nodes (i.e., nodes of different or distinct types). This aspect improves the performance of machine learning model 120 since now the model is able to learn from more information than conventionally possible. It is noted that conventional approaches are only able to learn information from two-hop nodes (or same-type nodes). To that end, the learning performance of the approach described in the present disclosure is higher than the conventional techniques.

In one embodiment, the payment network 112 may be used by the payment card issuing authorities as a payment interchange network. Examples of the payment cards 118 include debit cards, credit cards, etc. Similarly, examples of payment interchange networks include but are not limited to, a Mastercard® payment system interchange network. The Mastercard® payment system interchange network is a proprietary communications standard promulgated by Mastercard International Incorporated® for the exchange of electronic payment transaction data between issuers and acquirers that are members of Mastercard International Incorporated®. (Mastercard is a registered trademark of Mastercard International Incorporated located in Purchase, N.Y.).

It should be understood that the server system 102 is a separate part of the environment 100, and may operate apart from (but still in communication with, for example, via the network 116) any third-party external servers (to access data to perform the various operations described herein). However, in other embodiments, the server system 102 may be incorporated, in whole or in part, into one or more parts of the environment 100.

It is pertinent to note that the various embodiments of the present disclosure have been described herein with respect to examples from the financial domain, it should be noted the various embodiments of the present disclosure can be applied to a wide variety of applications as well and the same will be covered within the scope of the present disclosure as well. For instance, for recommender systems, the plurality of first entities may be users and the plurality of second entities may be items. In this instance, if a bipartite graph is generated then, the first set of nodes will correspond to the users and the second set of nodes will correspond to the items. Furthermore, the edges between the distinct nodes within the bipartite graph will represent interactions between the users and items. To that end, the various embodiments of the present disclosure apply to various applications as long as a dataset pertaining to the desired application can be represented in the form of a bipartite graph.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 116, which may be specifically configured, via executable instructions, to perform steps as described herein, and/or embodied in at least one non-transitory computer-readable media.

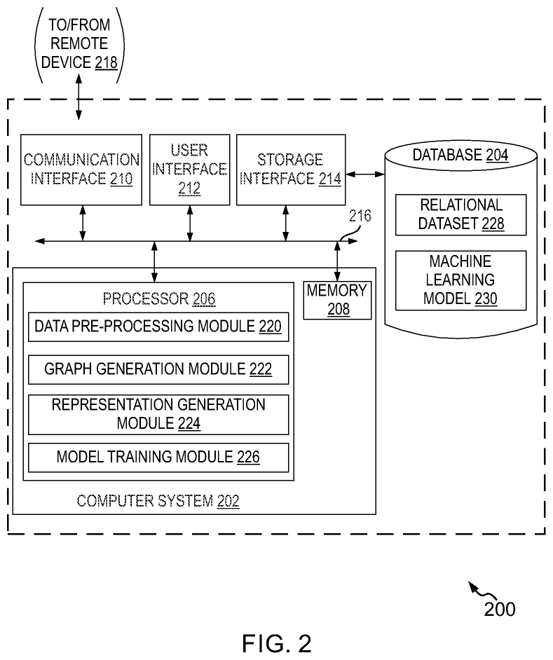

FIG. 2 illustrates a simplified block diagram of a server system 200, in accordance with an embodiment of the present disclosure. The server system 200 is identical to the server system 102 of FIG. 1. In one embodiment, the server system 200 is a part of the payment network 112 or integrated within the payment server 114. In some embodiments, the server system 200 is embodied as a cloud-based and/or Software as a Service (Saas) based architecture.

The server system 200 includes a computer system 202 and a database 204. The database 204 is identical to the database 122 of FIG. 1. The computer system 202 includes at least one processor 206 for executing instructions, a memory 208, a communication interface 210, a user interface 212, and a storage interface 214 that communicates with each other via a bus 216.

In some embodiments, the database 204 is integrated within the computer system 202. For example, the computer system 202 may include one or more hard disk drives as the database 204. The user interface 212 is any component capable of providing an administrator (not shown) of the server system 200, the ability to interact with the server system 200. This user interface 212 may be a GUI or Human Machine Interface (HMI) that can be used by the administrator to configure the various operational parameters of the server system 200. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one non-limiting example, the database 204 is configured to store relational dataset 228, a machine learning model 230), and the like. It is noted that the machine learning model 230 is identical to the machine learning model 120 of FIG. 1.

The processor 206 includes suitable logic, circuitry, and/or interfaces to execute operations for generating a task-agnostic representation for each node of a plurality nodes within a bipartite graph. In other words, the processor 206 includes suitable logic, circuitry, and/or interfaces to execute operations for the machine learning model. Examples of the processor 206 include but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing operations. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device (i.e., to/from a remote device 218) such as the plurality of issuer servers 110, the plurality of acquirer servers 108, the payment server 114, or communicating with any entity connected to the network 116 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing module 220, a graph generation module 222, a representation generation module 224, and a model training module 226. It should be noted that components, described herein, such as the data pre-processing module 220, the graph generation module 222, the representation generation module 224 and, the model training module 226 can be configured in a variety of ways, including electronic circuitries, digital arithmetic, and logic blocks, and memory systems in combination with software, firmware, and embedded technologies.

In an embodiment, the data pre-processing module 220) includes suitable logic and/or interfaces for accessing a relational dataset 228 from the database 204. In various-non-limiting examples, the relational dataset 228 may include information related to a plurality of first entities, a plurality of second entities, and a relationship between the plurality of first entities and the plurality of second entities.

In one non-limiting example, the plurality of entities may be segmented into the plurality of first entities and the plurality of second entities. In various non-limiting examples, the plurality of entities may include the plurality of cardholders 104, the plurality of merchants 106, a plurality of issuer servers 110, and a plurality of acquirer servers 108 as depicted in FIG. 1. Further, the information related to these entities may include information related to a plurality of historical payment transactions performed by the plurality of cardholders 104 with the plurality of merchants 106. It is noted that this non-limiting example is specific to the financial industry or payment ecosystem. To that end, the relational dataset 228 can be configured to include different information specific to any field of operation. Therefore, it is understood that the various embodiments of the present disclosure apply to a variety of different fields of operation and the same is covered within the scope of the present disclosure.

Returning to the example, the relational dataset 228 may include information related to a plurality of historical payment transactions performed within a predetermined interval of time (e.g., 6 months, 12 months, 24 months, etc.). In some other non-limiting examples, the relational dataset 228 includes information related to at least merchant name identifier, unique merchant identifier, timestamp information (i.e., transaction date/time), geo-location related data (i.e., latitude and longitude of the cardholder/merchant), Merchant Category Code (MCC), merchant industry, merchant super industry, information related to payment instruments involved in the set of historical payment transactions, cardholder identifier, Permanent Account Number (PAN), merchant DBA name, country code, transaction identifier, transaction amount, and the like.

In one example, relational dataset 228 may define a relationship between each of the plurality of entities. In a non-limiting example, a relationship between a cardholder account and a merchant account may be defined by the relational dataset 228. For instance, when a cardholder purchases an item from a merchant, a relationship is said to be established.

In another embodiment, the relational dataset 228 may include information related to past payment transactions such as transaction date, transaction time, geo-location of a transaction, transaction amount, transaction marker (e.g., fraudulent or non-fraudulent), and the like. In yet another embodiment, the relational dataset 228 may include information related to the plurality of acquirer servers 108 such as the date of merchant registration with the acquirer server (such as acquirer server 108(1), amount of payment transactions performed at the acquirer server 108(1) in a day, number of payment transactions performed at the acquirer server 108(1) in a day, maximum transaction amount, minimum transaction amount, number of fraudulent merchants or non-fraudulent merchants registered with the acquirer server 108(1), and the like.

In addition, the data pre-processing module 220 is configured to generate a first set of features for each of the plurality of first entities and a second set of features for each of the plurality of second entities based, at least in part, on the relational dataset 228.

More specifically, it is understood that the information related to the plurality of entities present within the relational dataset 228 can be broadly classified as information related to the first entity and information related to the second entity. This information corresponding to the first entity and the second entity can be used by the data pre-processing module 220 to generate the first set of features for each first entity of the plurality of first entities and the second set of features for each second entity of the plurality of second entities.

In various non-limiting examples, the data pre-processing module 220 may utilize any feature generation approach to generate the set of features (i.e., the first set of features and the second set of features). It is understood that such feature generation techniques are already known in the art, therefore the same are explained here for the sake of brevity.

In another embodiment, the data pre-processing module 220 is communicably coupled to the graph generation module 222 and is configured to transmit the first set of features and the second set of features to the graph generation module 222.

In an embodiment, the graph generation module 222 includes suitable logic and/or interfaces for generating a bipartite graph based, at least in part, on the relational dataset 228, the first set of features, and the second set of features. In various non-limiting examples, the bipartite graph may include a first set of nodes corresponding to the plurality of first entities and a second set of nodes corresponding to the plurality of second entities. It is noted that each node of the first set of nodes and each of the second set of nodes is connected by an edge. In other words, a set of edges exist between the first set of nodes and the second set of nodes. More specifically, each node of the first set of nodes and the second set of nodes correspond to the set of features. Further, each edge of the set of edges may indicate information related to a relationship between two distinct nodes in the bipartite graph. Herein, the distant nodes refer to the first set of nodes and the second set of nodes. For example, in the financial domain, the bipartite graph may be generated for the plurality of cardholders 104 and the plurality of merchants 106. In this example, the bipartite graph may be called a cardholder-merchant bipartite graph or merchant-cardholder bipartite graph. Further, the first set of nodes may be the plurality of cardholders 104 and the second set of nodes may be the plurality of merchants 106.

More specifically, at first, the first set of features, and the second set of features are fed to the graph generation module 222 along with the relational dataset 228. Then, the graph generation module 222 determines one or more features required for the generation of the bipartite graph by analyzing the information related to the plurality of first entities and the plurality of second entities included in the relational dataset 228. For instance, the one or more features corresponding to a first entity may be included in a node of the first set of nodes, and features corresponding to a second entity may be included in a node of the second set of nodes

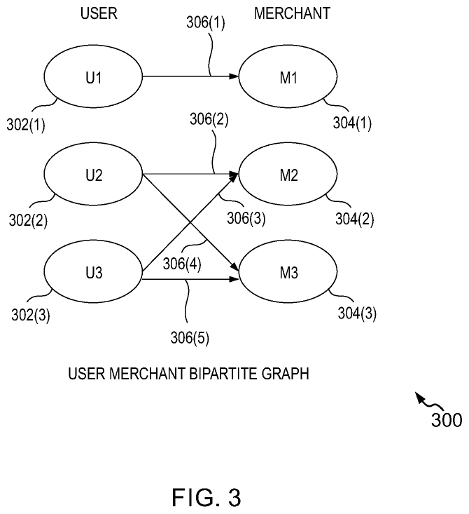

Then, these two nodes (one node corresponding to the first entity and the other node corresponding to the second entity) may be connected with one or more edges. Herein, the one or more edges may define the relationship between different nodes (i.e., nodes of different entity types). In a non-limiting example, the graph generation module 222 identifies the cardholders 104(1)-104(3) that have made payment transactions with the merchants 106(1)-106(3) based at least on the information related to historical payment transactions between the plurality of cardholders 104 and the plurality of merchants 106. More specifically, a cardholder-merchant bipartite graph may be generated by representing the cardholders 104(1)-104(3) and the merchants 106(1)-106(3) as nodes of different types and connecting these nodes a set of edges that represent a transaction between the distinct nodes. It is noted that an exemplary representation of a bipartite graph has been explained further in detail later in the present disclosure with reference to FIG. 3. Upon generation of the bipartite graph, the bipartite graph may be stored in the database 204 associated with the server system 200. It is noted that when the server system 200 has to determine task-agnostic representations for the plurality of nodes in the bipartite graph, the server system 200 may access the bipartite graph from the database 204. In a situation, where the bipartite graph is not available, the server system 200 may generate the bipartite graph based on the process describer earlier.

In another embodiment, the graph generation module 222 is communicably coupled to the representation generation module 224 and is configured to transmit the bipartite graph to the representation generation module 224.

In an embodiment, the representation generation module 224 includes suitable logic and/or interfaces for performing a set of steps for each node of the first set of nodes and the second set of nodes in the bipartite graph to determine its corresponding task-agnostic representation (or embedding). More specifically, the representation generation module 224 at first identifies a neighbor node of a particular node (i.e., the node for which the task-agnostic representation has to be determined). Herein, the natural neighbor node can be a two-hop neighbor node from this particular node. Then, the representation generation module 224 generates a temporary representation for a one-hop neighbor node of this particular node based, at least in part, on the set of features corresponding to the one-hop neighbor node. Further, the representation generation module 224 generates a temporary neighbor node based, at least in part, on the temporary representation for the one-hop neighbor node of this particular node. Then, the representation generation module 224 generates an augmented neighborhood for this particular node based, at least in part, on the natural node and the temporary neighbor node. It is noted that these aspects of the present disclosure have been described in detail with reference to FIG. 4B later in the present disclosure. Thereafter, the representation generation module 224 determines a task-agnostic representation for this particular node based, at least in part, on the augmented neighborhood. In one implementation, the machine learning model 230 may be utilized by the representation generation module 224 to determine the task-agnostic representation for the particular node based, at least in part, on the augmented neighborhood. In a non-limiting example, the machine learning model 230 may be a Multi-Task Bipartite Graph Neural Network (MultiBipGNN) based machine learning model. It is noted that the machine learning model 230 is identical to the machine learning model 120 of FIG. 1.

As may be understood, the augmented neighborhood enables the machine learning model 230 to learn from aggregated information from two-hop nodes (i.e., nodes of the same type) and one-hop nodes (i.e., nodes of different or distinct types). This aspect improves the performance of machine learning model 230 since now the model can learn from more information than conventionally possible. It is noted that conventional approaches are only able to learn information from two-hop nodes (or same-type nodes). To that end, the learning performance of the approach described in the present disclosure is higher than the conventional techniques.

In another embodiment, the representation generation module 224 is communicably coupled to the model training module 226 and is configured to utilize the model training module 226 to train and deploy the machine learning model 230 during an application.

In an embodiment, the model training module 226 includes suitable logic and/or interfaces for training the machine learning model 230 based, at least in part, on performing a set of operations iteratively till the performance of the machine learning model converges to predefined criteria. In a non-limiting scenario, the set of operations may include (1) initializing the machine learning model 230 based on one or more model parameters, (2) processing the bipartite graph via the machine learning model 230 by performing a set of tasks to compute a set of outputs, (3) generating task-specific loss corresponding to each task of the set of tasks, and (4) optimizing the one or more model parameters based, at least in part, on back-propagating the task-specific loss corresponding to each task of the set of tasks. It is noted that predefined criteria may refer to a point in the iterative process where the value task-specific loss corresponding to each task of the set of tasks either minimizes or saturates (i.e., stops to decrease with successive iterations).

More specifically, the model training module 226 is configured to first initialize the machine learning model 230 based, at least in part, on one or more model parameters. In various non-limiting examples, the machine learning model 230 may include a set of shared layers and a set of task-specific layers. For instance, the one or more model parameters may define the various aspects related to the set of shared layers and the set of task-specific layers of the machine learning model 230. Then, the model training module 226 is configured to process via the machine learning model 230, the bipartite graph by performing a set of tasks to compute a set of outputs. In various non-limiting examples, the set of tasks may include a set of generative tasks and a set of entropy-based tasks (described later). Then, the model training module 226 is configured to generate a task-specific loss corresponding to each task of the set of generative tasks and the set of entropy-based tasks based, at least in part, on the set of outputs and the relational dataset. Thereafter, the model training module 226 is configured to optimize the one or more model parameters based, at least in part, on back-propagating the task-specific loss corresponding to each task of the set of generative tasks and the set of entropy-based tasks.

As may be understood, the above-mentioned process for training the machine learning model 230 is an example of multi-task learning. It is noted that the multi-task learning models generally suffer from the problem of negative transfer which leads to poor learning performance. It is noted that the negative transfer takes place due to poor learning performance of the machine learning model 230 while learning by performing the one or more tasks from the set of tasks. In such a scenario, the one or more tasks may be called weak learning tasks. To solve this problem, the model training module 226 is configured to compute a task-specific activation probability for each task of the set of tasks. Then, the model training module 226 is configured to perform one of step (1) or step (2). The step (1) includes scheduling one or more tasks from the set of tasks to activate based, at least in part, on the task-specific activation probability computed for the corresponding task being lower than a predefined threshold. On the other hand, the step (2) includes scheduling the one or more tasks from the set of tasks to deactivate based, at least in part, on the task-specific activation probability computed for the corresponding task being at least equal to the predefined threshold. In a non-limiting example, the predefined threshold may be defined by an administrator of the server system 200 (not shown). It is noted that this aspect of the present disclosure has been described in detail later with reference to FIG. 4C.

In an implementation, the model training module 226 is configured to process the bipartite graph by performing the set of tasks that may include at first, processing via the machine learning model 230, the bipartite graph by performing the set of generative tasks.

In a non-limiting implementation, the set of generative tasks may include at least one of a feature reconstruction task and a topological reconstruction task. When the task is a feature reconstruction task, the model training module 226 is at first configured to mask a subset of features from the set of features corresponding to each node of a subset of nodes of the bipartite graph. Then, the model training module 226 is configured to predict via the machine learning model 230, the subset of features corresponding to the each node based, at least in part, on the remaining features from the set of features corresponding to the each node. Then, the model training module 226 is configured to compute a feature reconstruction loss for the subset of nodes based, at least in part, on the predicted subset of features and the subset of features. It is noted that herein, the feature reconstruction loss may be considered to be a part of the task-specific loss corresponding to the feature reconstruction task of the set of generative tasks described earlier. Thereafter, the model training module 226 is configured to fine-tune the one or more model parameters based, at least in part, on back-propagating the feature reconstruction loss.

When the task is a topological reconstruction task, the model training module 226 is at first configured to mask a subset of edges from the set of edges associated with a subset of nodes of the bipartite graph. Then, the model training module 226 is configured to predict via the machine learning model 230, the subset of edges associated with a subset of nodes of the bipartite graph based, at least in part, on the remaining edges from the set of edges. Then, the model training module 226 is configured to compute a topological reconstruction loss for the subset of nodes based, at least in part, on the predicted subset of edges and the subset of edges. It is noted that herein, the topological reconstruction loss may be considered to be a part of the task-specific loss corresponding to the topological reconstruction task of the set of generative tasks described earlier. Thereafter, the model training module 226 is configured to fine-tune the one or more model parameters based, at least in part, on back-propagating the topological reconstruction loss.

In another implementation, the model training module 226 is configured to process the bipartite graph by performing the set of tasks that may include at first, processing via the machine learning model 230, the bipartite graph by performing the set of entropy-based tasks.

In a non-limiting implementation, the set of entropy-based may include at least one of a contrastive learning task, a mutual information maximization for edge-graph task, and a mutual information maximization for sub-graph-graph task. When the task is the contrastive learning task, the model training module 226 is at first configured to compute via the machine learning model 230, an actual representation for the each node based, at least in part, on the set of features corresponding to the each node. Then, the model training module 226 is configured to generate a neighbor node representation for the one-hop neighbor node of each node of a subset of nodes of the bipartite graph based, at least in part, on the set of features corresponding to the one-hop neighbor node. Then, the model training module 226 is configured to predict via the machine learning model 230, a predicted representation for the each node based, at least in part, on the neighbor node representation. Then, the model training module 226 is configured to compute a contrastive loss for the each node based, at least in part, on the predicted representation and the actual representation. It is noted that herein, the contrastive loss may be considered to be a part of the task-specific loss corresponding to the contrastive learning task of the set of entropy-based tasks described earlier. Thereafter, the model training module 226 is configured to fine-tune the one or more model parameters based, at least in part, on back-propagating the contrastive loss.

When the task is the mutual information maximization for edge-graph task, the model training module 226 is at first configured to compute via the machine learning model 230, an edge representation for an edge of the set of edges based, at least in part, on the information related to a relationship between two distinct nodes connected by the edge. Then, the model training module 226 is configured to compute via the machine learning model 230, a graph representation for the bipartite graph based, at least in part, on the set of features corresponding to each node of the bipartite graph. Then, the model training module 226 is configured to compute an edge-graph loss for the edge based, at least in part, on the edge representation and the graph representation. It is noted that herein, the edge-graph loss may be considered to be a part of the task-specific loss corresponding to the mutual information maximization for edge-graph task of the set of entropy-based tasks described earlier. Thereafter, the model training module 226 is configured to fine-tune the one or more model parameters based, at least in part, on back-propagating the edge-graph loss.

When the task is the mutual information maximization for sub-graph-graph task, the model training module 226 is at first configured to extract a sub-graph from the bipartite graph based, at least in part, on a predefined set of rules. In various non-limiting examples, the predefined set of rules may define based on which aspects the sub-graph should be extracted from the main graph. It is noted that the predefined set of rules may be defined by the administrator (not shown) of the server system 200. Then, the model training module 226 is configured to compute via the machine learning model 230, a sub-graph representation for the sub-graph based, at least in part, on the set of features corresponding to each node of the sub-graph. Then, the model training module 226 is configured to compute via the machine learning model 230, a graph representation for the bipartite graph based, at least in part, on the set of features corresponding to each node of the bipartite graph. Then, the model training module 226 is configured to compute a sub-graph-graph loss for the sub-graph based, at least in part, on the sub-graph representation and the graph representation. It is noted that herein, the sub-graph-graph loss may be considered to be a part of the task-specific loss corresponding to the mutual information maximization for sub-graph-graph task of the set of entropy-based tasks described earlier. Thereafter, the model training module 226 is configured to fine-tune the one or more model parameters based, at least in part, on back-propagating the sub-graph-graph loss.

As may be understood, the machine learning mode 230 is a multi-task SSL algorithm that learns in a self-supervised manner by performing the set of tasks. In the non-limiting example described above, five tasks are used are pretext tasks for training the machine learning model 230. Furthermore, the machine learning model 230 is also able to dynamically schedule one or more tasks from the set of tasks to be activated or deactivated during the learning or training process, which improves the overall learning of the model during the leaning process of the machine learning model 230 while reducing the phenomenon of negative transfer between different tasks during the learning or training process. It should be noted that this aspect of the machine learning model 230 also improves its performance while generating a task-agnostic representation for each node of the bipartite graph.

FIG. 3 illustrates an exemplary representation of a bipartite graph 300, in accordance with an embodiment of the present disclosure. As described earlier, the graph generation module 222 of the server system 200 is configured to generate a bipartite graph 300 based, at least in part, on the relational dataset 228, the first set of features, and the second set of features. Upon referring to FIG. 3, it is understood that a bipartite graph 300 between a user and a merchant is shown. The bipartite graph 300 as illustrated is an example of a user-merchant bipartite graph (referred to hereinafter as user-merchant bipartite graph 300′). Further, the user-merchant bipartite graph 300 includes a plurality of nodes (see, 302(1), 302(2), 304(3), 304(1), 304(2), and 304(3)) connected via a plurality of edges (see, 306(1), 306(2), 306(3), 306(4), and 306(5)). In this example, the nodes 302(1)-302(3) represent a plurality of users (see, U1, U2, and U3) and the nodes 304(1)-304(3) represent a plurality of merchants (see, M1, M2, and M3). It is noted that the plurality of edges 306(1)-306(5) indicates a relationship between the plurality of users U1-U3 and the plurality of merchants M1-M3. Herein, the relationship can be defined as a set of transactions performed between the plurality of cardholders U1-U3 and the plurality of merchants M1-M3.

In particular, for generating a bipartite graph, such as a user-merchant bipartite graph 300, the cardholder-merchant interaction data (i.e., transaction-related data from the relational dataset 228) for a specific timeline T is used to generate the user related features and the merchant related features. Further, the bipartite graph G_{b}=(M, U, E) is generated based on the user related features and the merchant related feature. Herein, the notations M, and U represent the plurality of merchants (such as M1-M3), and the plurality of users (such as U1-U3) interacting in the timeline T and E representing the edges or interactions between them. Now; for a merchant mᵢ and user uⱼ in the bipartite graph, there exists an edge eᵢⱼ if the cardholder cⱼ transacted with merchant mᵢ during the timeline T.

FIGS. 4A, 4B, and 4C, collectively, illustrate an architecture of the machine learning model 230, in accordance with an embodiment of the present disclosure.

In particular, FIG. 4A illustrates a representation 400 of the complete architecture of the Multi-Task Self-Supervised Learning (MT-SSL) process, in accordance with an embodiment of the present disclosure. Further, FIG. 4B illustrates a process 422 for generating node embeddings using the bipartite graph of FIG. 4A in more detail, in accordance with an embodiment of the present disclosure. Furthermore, FIG. 4C illustrates a representation of an architecture 424 of a Dropped-Scheduled Task (DST) algorithm, in accordance with an embodiment of the present disclosure. To that end, as depicted in FIG. 4A, a bipartite graph 402 is subjected to an SSL task-specific augmentation 404. Then, the bipartite graph 402 with the SSL task-specific augmentation 404 is fed to a GNN encoder 406. The GNN encoder 406 may include a convolution layer 1 (see, 408) and a convolution layer 2 (see, 410). The GNN encoder 406 is configured to process the bipartite graph 402 with SSL task-specific augmentation 404 for generating node embeddings 412 for the bipartite graph 402. It is noted that the generated node embedding of each node is the task-agnostic representation for each node.

Further, the GNN encoder 406 is trained using a task-specific projection 414 from each of the set of tasks. In particular, the objective formulation 416 required for training the GNN encoder 406 is provided by the respective loss values (see, 418) generated during the model training phase based on performing the set of tasks. More specifically, the set of tasks includes two families of tasks that are used to train the machine learning model 230. Herein, the two families of tasks include a set of generative tasks and a set of entropy-based tasks. In a non-limiting implementation, the set of generative tasks includes a feature reconstruction task (see, block 420A) and a topological reconstruction task (see, block 420B). In another non-limiting implementation, the set of entropy-based tasks includes a contrastive learning task (see, block 420C), a mutual information maximization for the edge-graph task (see, block 420D), and a mutual information maximization for the sub-graph-graph task (see, block 420E). It is noted that the term ‘mutual information maximization for edge-graph task’ may interchangeably be referred to as ‘mutual information maximization for node-graph task’ as well. The contrastive learning task is used to perform contrastive learning between two nodes.

As may be understood, a bipartite graph 402 may be represented by G=(U, V, E), where U and V are two separate sets of nodes, and E⊂U×V represents the edges. For instance, U may be the first set of nodes and V may be the second set of nodes. Herein, it is noted that G includes two types of nodes: those that belong to the same set are similar, while those in different sets are dissimilar. Let A be a binary adjacency matrix of size |U|×|V|, where each element Aᵢⱼ indicates whether a node uᵢ∈U has a connection with a node vᵢ∈V. It is understood that bipartite graph embedding (or representation) aims to assign a d-dimensional vector to each node in G, denoted as uᵢ and vⱼ for uᵢ and vⱼ, respectively.

Further, the process 422 shown in FIG. 4B implements a bipartite graph encoder that is used as the shared backbone of the multi-task network. More specifically, two encoders are trained, the first encoder is configured to learn learning representations (or embeddings) of u-type nodes, and the second encoder is configured to learn learning representations (or embeddings) of v-type nodes. As may be understood, since the direct neighbors (i.e., neighboring nodes) in the bipartite graph 402 are of different types, the conventional message-passing mechanism of homogeneous graphs cannot be applied to bipartite graphs. Therefore, the message passing for uᵢ^{k} as follows, with \hat{v}ⱼ^{k} also following the same process. First, temporary representations \hat{v}ⱼ^{k} are generated via a mean aggregation based on Eqn. (1):

$${\hat{v}}_{j}^{k} = δ ( {\hat{W}}_{v}^{k} \cdot MEAN ( {u}_{i}^{k - 1} : {u}_{i} ∈ N ( {v}_{j} ) ) ) \qquad Eqn . ( 1 )$$

where, k is the layer, δ is the non-linear activation, W^{k} is a weight matrix, and N(vⱼ) denotes one-hop neighbors of vⱼ. As may be understood, due to its construction, \hat{v}ⱼ^{k} can now be considered a u-type embedding. Now at the one hop, there are two types of neighbors: vⱼ^{k-1}, the natural neighbor, and \hat{v}ⱼ^{k}, the constructed temporary neighbor. Then, a non-linear transform may be applied on vⱼ using a Multi-Layer Perceptron (MLP) and thereafter, both kinds of neighbors and the self-node are aggregated using multi-head soft attention (MHSA). It is noted that the MLP is used to perform domain adaptation for the distinct nodes. However, it may be noted that any suitable algorithm that is capable of applying a non-linear transform may be used instead of the MLP algorithm without departing from the scope of the present disclosure.

Then, an augmented neighborhood is generated for a node uᵢ, consisting of all the one-hop natural neighbors vⱼ and temporary neighbors \hat{v}ⱼ. Thereafter, feature representation for the node uᵢ is learned by performing a graph attention-based convolution using MHSA on the augmented neighborhood.

$${α}_{ij}^{k} = \frac{exp ( δ ( {a}^{T} [ {W}_{u}^{k} {u}_{i}^{k - 1} \vert \vert {W}_{u}^{k} {v}_{j}^{k - 1} ) )}{{\sum }_{l ∈ {N}_{i}} exp ( δ ( {a}^{T} [ {W}_{u}^{k} {u}_{i}^{k - 1} \vert \vert {W}_{u}^{k} {v}_{l}^{k - 1} ] ) )} \qquad Eqn . ( 2 )$$

$${u}^{i} = δ ( \frac{1}{N} {\sum }_{n = 1}^{N} {\sum }_{j ∈ {N}_{i}} {α}_{ij}^{k} {W}_{u}^{k} {v}_{j}^{k - 1} ) \qquad Eqn . ( 3 )$$

Here, αᵢⱼ^{k} denotes the attention weights that aggregate information over the augmented neighborhood, δ is the non-linear activation, and α is an MLP which adds further expressivity to the attention mechanism. Furthermore, to stabilize attention, N heads are used and an average is taken to obtain the final embedding.

It is noted that to build the intuition of the algorithm, information from the same type of nodes is required for message passing. However, complementary information from the other node type can also assist. Hence, we aggregate the two kinds of neighbors using MHSA, which can decide how much to weigh each piece of information. Further, an MLP may be used for implicit domain alignment between the two feature domains u and v.

Furthermore, a machine learning model such as machine learning model 230 may be trained based on a Multi-task learning approach that utilizes five different pretext tasks to cover three high-level philosophies: (1) generative reconstruction, (2) contrastive learning, and (3) maximizing mutual information between local and global representations.

The five tasks may be classified as a set of generative tasks and a set of entropy-based tasks. More specifically, the set of generative tasks may include at least one of a feature reconstruction task and a topological reconstruction task and the set of entropy-based tasks may include at least one of a contrastive learning task, a mutual information maximization for edge-graph task, and a mutual information maximization for sub-graph-graph task.

The set of generative tasks aims to generate node features (feature reconstruction) and topology (topological reconstruction) from its embedding. In the feature reconstruction task, the machine learning model 230 (such as the MultiBipGNN) may be used to at first, encode node features by masking the features of a random batch of nodes.

Next, the masked node features are reconstructed after re-masking them against the node representations. For the same, the u-encoder (i.e., the first encoder), f_{g,u}, to reconstruct the representations for u-type nodes and v-encoder (i.e., the second encoder), f_{g,v} to reconstruct for v-type nodes. In a non-limiting example, the following equations (Eqn. (4) and Eqn. (5)) describe the reconstruction loss for u-type nodes.

$${\hat{X}}_{u}^{′} = {A}^{′} \cdot {f}_{g , u} ( {G}^{′} ; {θ}_{g , u} ) ⊙ {M}_{u} \cdot {W}_{u}^{Dec} \qquad Eqn . ( 4 )$$

$${ℒ}_{FeatRec , u} = \frac{{‖ {\hat{X}}_{u}^{′} ⊙ {\hat{M}}_{u} - {X}_{u}^{′} ⊙ {\hat{M}}_{u} ‖}_{F}}{{‖ {X}_{u}^{′} ⊙ {\hat{M}}_{u} ‖}_{F}} \qquad Eqn . ( 5 )$$

Here, ⊙ refers to the Hadamard product, Xᵤ′ is the feature matrix of the sampled sub-graph, A′ is the adjacency matrix for the same and Mᵤ and \hat{M}ᵤ are the masked and re-masked feature matrices. The final loss, i.e., the feature reconstruction loss to be minimized for feature reconstruction is given by the sum of u-type and v-type losses.

In the topological reconstruction task, the machine learning model 230 (such as the MultiBipGNN) may also be used to reconstruct links (i.e., edges) between connected nodes to retain pair-wise topological knowledge. Given a sampled sub-graph G′, B positive node pairs may be randomly sampled where the links (or edges) exist and B negative node pairs may be randomly sampled where no edge exists. In a non-limiting example, the probability of a connection existing between two nodes is calculated may be calculated based on the Eqn. (6) given below:

$${P}_{link} ( i , j ) = δ ( ( {f}_{u} ( {G}^{′} ; {θ}_{g , u} ) [ {u}_{i} ] ⊙ {f}_{v} ( {G}^{′} ; {θ}_{g , v} ) [ {v}_{j} ] ) \cdot {W}^{Topo} ) \qquad Eqn . ( 6 )$$

Finally, topological reconstruction maximizes the probabilities of positive node pairs and minimizes the probabilities for negative node pairs to compute the topological reconstruction loss. In a non-limiting example, the topological reconstruction loss is calculated may be calculated based on the Eqn. (7) given below:

$${ℒ}_{TopoRec} = \frac{- 1}{2 B} {\sum }_{( {u}_{i} , {v}_{j} ) ∈ {V}^{+}} log ( {P}_{link} ( {u}_{i} , {v}_{j} ) ) + {\sum }_{( {u}_{i} , {v}_{j} ) ∈ {V}^{-}} log ( 1 - ( {P}_{link} ( {u}_{i} , {v}_{j} ) ) ) \qquad Eqn . ( 7 )$$

The Contrastive learning task aims to maximize mutual information by contrasting positive pairs with negative-sampled counterparts. At first, a formulation for bipartite graphs is defined. While pre-training the GNN, encoder 406 a random set of N sub-graphs is chosen and used in contrastive learning. This process results in 2N augmented graphs, which are used to optimize the contrastive loss. Here, u-nodes are contrasted with u-type nodes to obtain positive examples for the u-type anchor. On the contrary, negative pairs are not explicitly sampled but obtained from the other augmented graphs in the same set of N sub-graphs. It is noted that u_{n,i} and u_{n,j} are the positive samples that are generated using augmentation from the same node. Further, the sim is a similarity measure akin to cosine similarity. It is understood that the process can be followed for the v-type nodes as well. Lastly, the final contrastive learning loss to be minimized may be given by the sum of u-type and v-type losses. In a non-limiting example, the contrastive loss is calculated may be calculated based on the Eqn. (8) given below:

$${ℒ}_{Contrastive , u} = - log \frac{exp ( sim ( {u}_{n , i} {u}_{n , j} ) / τ )}{{\sum }_{{n}^{′} = 1 , {n}^{′} \neq n}^{N} exp ( sim ( {u}_{n , i} {u}_{{n}^{′} , j} ) / τ )} \qquad Eqn . ( 8 )$$

Mutual Information Maximization based tasks involve maximizing the mutual information between two views of the same target, which assists in learning the intrinsic patterns. To maximize local-global mutual information, the distance between the intact graph-level representation and its edge representations has to be minimized while simultaneously maximizing the distance between the former and the corrupted edge representations. In a non-limiting example, the mutual information between the edge embeddings and the global representation of the graph is maximized on the following Eqn. (9).

$${ℒ}_{MI}^{1} = \frac{1}{N + M} ( {\sum }_{i = 1}^{N} {E}_{( X , A )} [ log D ( {h}_{i} , g ) ] + {\sum }_{j = 1}^{M} {E}_{( \tilde{X} , \tilde{A} )} [ log ( 1 - D ( {\tilde{h}}_{j} , g ) ) ] ) \qquad Eqn . ( 9 )$$

Here, g is the graph representation, defined using the mean over node representations for both u-type and v-type and then, concatenated. Similarly, the local edge representation h is computed by concatenating node representations of u and v. As a proxy for maximizing the mutual information, a discriminator D(hᵢ,g) is employed. This represents the probability scores assigned to the patch-summary pair (higher score for patches contained within the summary).

Further, the mutual information between sub-graph and global graph representations is also maximized. More specifically, the mutual information between the embeddings of a sub-graph defined around an edge and the global representation is maximized.

$$\begin{matrix}{p}_{u} = MEAN ( {u}_{i} ; {u}_{i} ∈ U ) , {p}_{v} = ( {v}_{i} ; {v}_{i} ∈ V ) , \\ g = COM ( {p}_{u} , {p}_{v} ) = [ σ ( {p}_{u} ) \vert σ ( {p}_{v} ) ]\end{matrix} \qquad Eqn . ( 10 )$$

$${g}_{( u , v )}^{h} = [ σ ( {\sum }_{{v}_{i} ∈ {G}^{h} ( u )} {a}_{u , i} {v}_{i} + u ) \vert σ ( {\sum }_{{u}_{i} ∈ {G}^{h} ( u )} {a}_{v , i} {u}_{i} + v ) ] \qquad Eqn . ( 11 )$$

Here, g is the global graph representation and g_{(u,v)}^{h} is the sub-graph representation. Herein, g_{(u,v)}^{h} is computed around edges u and v. Further, g_{(u,v)}^{h} is defined by taking a h-hop neighborhood and learning attention weights for both u and v. Finally, as described using Eqn. (12), the mutual information between the subgraph and global graph representation is maximized using the actual graph and its corrupted version.

$${ℒ}_{MI}^{2} = \frac{1}{N + M} ( {\sum }_{i = 1}^{N} {E}_{( X , A )} [ log D ( {g}_{( u , v )}^{h} , g ) ] + {\sum }_{j = 1}^{M} {E}_{( \tilde{X} , \tilde{A} )} [ log ( 1 - D ( , g ) ) ] ) \qquad Eqn . ( 12 )$$

Further, as may be understood, when the learning process is performed using Multiple tasks. In other words, where multiple tasks are jointly optimized, one or more tasks from the set of tasks might dominate the learning process due to the varying nature and complexity of different tasks. Due to this aspect of Multi-Task Learning (MTL), for the remaining tasks from the set of tasks, the performance of the model may get compromised due to a negative transfer from the dominant tasks. To that end, a Dropped-Scheduled Task (DST) algorithm (depicted in FIG. 4C) may be trained such that the DST algorithm probabilistically ‘drops’ or deactivates one or more tasks during the joint optimization while scheduling the remaining tasks to stay activated. Thus, reducing the negative transfer. In particular, a task-specific activation probability is computed for each task of the set of tasks. More specifically, the task-specific activation probability is computed based at, least in part, on a set of metrics. In a non-limiting example, the set of metrics may include at least one of a task depth, a number of ground truth samples per task, the amount of training completed, and task stagnancy.

Furthermore, one or more tasks from the set of tasks may be scheduled to stay activated based, at least in part, on the task-specific activation probability computed for the corresponding task being lower than a predefined threshold. On the other hand, the one or more tasks from the set of tasks may be scheduled to deactivate based, at least in part, on the task-specific activation probability computed for the corresponding task being at least equal to the predefined threshold. In an instance, the predefined threshold may be defined by an administrator (not shown) of the server system 200. For instance, in the architecture 424 of DST shown in FIG. 4C, the MTL is performed using tasks A, B, and C, then task A is deactivated while task B and task C remain active to ensure positive transfer between task B and task C while eliminating negative transfer from task A.

It is noted that various experiments have been conducted on publicly available datasets to train and test the machine learning model 230 (i.e., the MultiBipGNN). In particular, extensive experimentation has been performed with different tasks using four open (i.e., publicly available) benchmark datasets. These datasets include MovieLens-100k (ML), Amazon CD (AC), Amazon Movie (AM), and Aminer Paper-Author (PA) datasets. Table 1 lists the statistics for different datasets including the number of nodes, types of nodes, and number of edges in the graph. As may be understood, the aim of using such a wide range of datasets and tasks is to thoroughly evaluate the generalizable nature of the various embodiments described in the present disclosure.

At the onset, the proposed approach is assessed using node classification, node regression, and link prediction tasks as three common downstream tasks. The metrics used to evaluate each task's performance are Accuracy (Acc), Mean Squared Error (MSE), and Area under the Curve (AUC). To carry out node regression, three datasets have been used. These three datasets include the AC dataset, AM dataset, and ML dataset. For the link prediction task, the same three datasets are used. Further, to perform the node classification task, we make use of the PA dataset is used, which involves a subset of Aminer papers published in the top 10 venues.

TABLE 1
Dataset statistics

| Dataset | Node Types | \|U\| | \|V \| | \|E\| |
|---|---|---|---|---|
| MovieLens- | User, Movie | 943 | 1,682 | 100,000 |
| 100 k | | | | |
| Amazon Music | User, Movie | 53,986 | 54,523 | 453,228 |
| Amazon CD | User, CD | 44,025 | 48,856 | 946,138 |
| Paper-Author | Author, Paper | 79,250 | 47,385 | 260,89 |

To conduct the various downstream tasks, a standard linear evaluation protocol has been used on graphs. As may be understood, for all three tasks, this evaluation protocol entails freezing the parameters of the GNN encoder, retrieving the embeddings of the corresponding nodes during inference, and training only linear models. For datasets whose splits are available, the public splits provided have been utilized for evaluation. However, for other datasets, an 80%/10%/10% split has been adopted for training/validation/testing, which is consistent with the methodology used in the conventional approaches.

As can be seen from Table 2, the state-of-the-art (SoTA) unsupervised graph representation learning methods from the homogeneous, heterogeneous, and bipartite graph literature have been compared with the proposed approach.

It is noted that the proposed approach has been compared with strong homogeneous methods like Node2Vec, Graph-SAGE, and GAT. It is noted that although Node2Vec employs Skip-Gram to acquire node embeddings that maintain the graph's structure, it fails to employ the features of the nodes. Further, Graph-SAGE and GAT aim to preserve the local graph structure by aggregating neighboring features. On the Heterogeneous side, the proposed approach has been compared with Metapath2Vec.

As described earlier, several conventional techniques learn representations for bipartite graphs as homogeneous and heterogeneous methods which prove to be suboptimal due to problems such as Hubness. Further, the proposed approach has been compared with algorithms like BiNE, C-BGNN, and BiGI.

It is noted that Table 2 shows that none of the conventional techniques and algorithms can perform favorably on all downstream tasks across all datasets. Furthermore, when it comes to specific tasks, techniques such as BiGI excel at link prediction but struggles with node classification and node regression. Similarly, C-BGNN is less effective for other tasks than node regression and classification. As detailed earlier, an experiment for the node regression task is performed using three datasets AC, AM, and ML. In AC and AM the task is to predict the mean rating of a CD and Movie respectively, whereas in ML, the task is to predict the user's age. It is understood, for comparing the performance of the various techniques and approaches, a Mean Squared Error (MSE) is computed. As may be gathered from Table 2, a relative improvement of approximately 10% can be seen using the proposed approach across all three datasets relative to the corresponding best-performing baseline. For the link prediction task, three datasets have been used, i.e., the CD dataset, AM dataset, and ML dataset. As may be understood, in the AC dataset, a connection between a user and a CD signifies that the user has given a rating to that particular CD. Likewise, in the AM and ML datasets, a link exists if a user has rated a movie.

As can be gathered from Table 2, the proposed approach has shown a comparative improvement of approximately 7% for all three datasets. Further, the PA dataset has been used for the node classification task where the aim is to predict the venue of a paper. Here, the proposed approach also shows an improvement of 5%. It should be noted that these results establish that the proposed approach or techniques of the present disclosure are easily generalizable across a variety of tasks and datasets due to the usage of multiple SSL tasks and the DST algorithm to coordinate these multiple SSL tasks. To that end, the MultiBipGNN model outperforms baselines on all tasks, in contrast to competing baselines, which excel on a single task.

TABLE 2
Performance comparison with conventional
techniques and approaches

| | | | | | | | Classi- |
|---|---|---|---|---|---|---|---|
| | | | | Link | | | fication |
| | Regression (MSE) | | | Prediction(AUC) | | | (Acc) |
| Method | AC | AM | ML | AC | AM | ML | PA |
| Node2Vec | 0.50 | 0.52 | 0.71 | 0.80 | 0.82 | 0.62 | 0.50 |
| GraphSage | 0.32 | 0.41 | 0.67 | 0.76 | 0.80 | 0.64 | 0.55 |
| GAT | 0.32 | 0.38 | 0.79 | 0.72 | 0.75 | 0.70 | 0.56 |
| Metapath2vec | 0.36 | 0.42 | 0.70 | 0.85 | 0.86 | 0.62 | 0.55 |
| BINE | 0.34 | 0.50 | 0.71 | 0.86 | 0.86 | 0.75 | 0.54 |
| BiGi | 0.36 | 0.40 | 0.81 | 0.91 | 0.92 | 0.82 | 0.54 |
| C-BGNN | 0.31 | 0.37 | 0.65 | 0.85 | 0.88 | 0.75 | 0.58 |
| MultiBipGNN | 0.29 | 0.36 | 0.63 | 0.92 | 0.94 | 0.95 | 0.60 |

An ablation study has also been performed for analyzing the performance of the various components (or embodiments) of the proposed algorithm. The results of the ablations study have been shown in Table 3. It can be seen that a model designed for single-task is not efficient to give competitive results on different downstream tasks for all datasets. This reveals that knowledge learned through a single methodology is not enough for consistent task generalization. Models trained on a single pretext task alone can only provide satisfactory results on a few tasks or datasets, making them narrow experts. For example, Feature Reconstruction performs well on node classification and regression but performs poorly on all other tasks. Similarly, MI-Sub-graph-Graph performs well on link prediction but underperforms on other tasks. However, when we compared these models with the model which is trained on a combination of all pretext tasks through weighted summation (i.e., by scheduling the set of tasks or pretext tasks), it can be seen that the latter achieved both robust task generalization and stronger single-task performance. Multiple objectives help regularize the learning model against extracting unessential information, enabling the model to learn multiple complementary views of the given bipartite graphs.

TABLE 3
Ablation Results

| | | | | | | | Classi- |
|---|---|---|---|---|---|---|---|
| | | | | Link | | | fication |
| | Regression (MSE) | | | Prediction(AUC) | | | (Acc) |
| Method | AC | AM | ML | AC | AM | ML | PA |
| MI-Edge-Graph | 0.35 | 0.38 | 0.78 | 0.88 | 0.90 | 0.80 | 0.55 |
| MI-Subgraph- | 0.36 | 0.40 | 0.81 | 0.91 | 0.92 | 0.82 | 0.54 |
| Graph | | | | | | | |
| Topological | 0.34 | 0.40 | 0.76 | 0.86 | 0.89 | 0.80 | 0.52 |
| Reconstruction | | | | | | | |
| Feature | 0.31 | 0.38 | 0.65 | 0.80 | 0.80 | 0.73 | 0.58 |
| Reconstruction | | | | | | | |
| Contrastive | 0.32 | 0.37 | 0.70 | 0.84 | 0.80 | 0.76 | 0.56 |
| Learning | | | | | | | |
| MultiBipGNN | 0.29 | 0.36 | 0.63 | 0.92 | 0.94 | 0.95 | 0.60 |

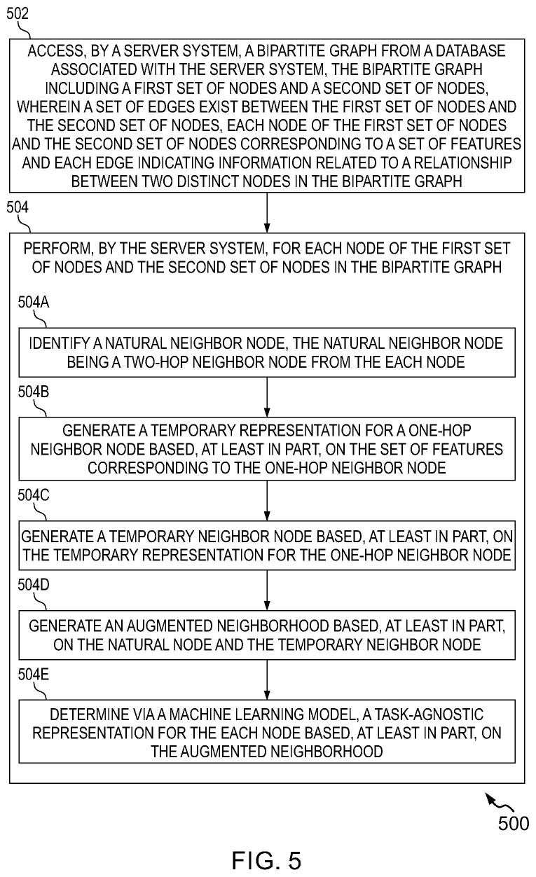

FIG. 5 illustrates a process flow diagram depicting a method 500 for generating a task-agnostic representation for the each node of a bipartite graph, in accordance with an embodiment of the present disclosure. The method 500 depicted in the flow diagram may be executed by, for example, the server system 200. The sequence of operations of the method 500 may not be necessarily executed in the same order as they are presented. Further, one or more operations may be grouped and performed in the form of a single step, or one operation may have several sub-steps that may be performed in parallel or in a sequential manner. Operations of the method 500, and combinations of operations in the method 500 may be implemented by, for example, hardware, firmware, a processor, circuitry, and/or a different device associated with the execution of software that includes one or more computer program instructions. The plurality of operations is depicted in the process flow of the method 500. The process flow starts at operation 502.

At 502, the method 500 includes accessing, by a server system such as server system 200 of FIG. 2, a bipartite graph from a database such as database 204 associated with the server system 300. In an example, the bipartite graph such as bipartite graph 402 may include a first set of nodes and a second set of nodes. Herein, a set of edges may exist between the first set of nodes and the second set of nodes in the bipartite graph 402. In another example, each node of the first set of nodes and the second set of nodes may correspond to a set of features. Further, each edge may indicate information related to a relationship between two distinct nodes in the bipartite graph.

At 504, the method 500 includes performing, by the server system 200, for each node of the first set of nodes and the second set of nodes in the bipartite graph 402 operations 504A-504E.

At 504A, the method 500 includes identifying a natural neighbor node, the natural neighbor node being a two-hop neighbor node from the each node.

At 504B, the method 500 includes generating a temporary representation for a one-hop neighbor node based, at least in part, on the set of features corresponding to the one-hop neighbor node.

At 504C, the method 500 includes generating a temporary neighbor node based, at least in part, on the temporary representation for the one-hop neighbor node.

At 504D, the method 500 includes generating an augmented neighborhood based, at least in part, on the natural node and the temporary neighbor node.

At 504E, the method 500 includes determining via a machine learning model such as machine learning model 230 of FIG. 2, a task-agnostic representation for the each node based, at least in part, on the augmented neighborhood.

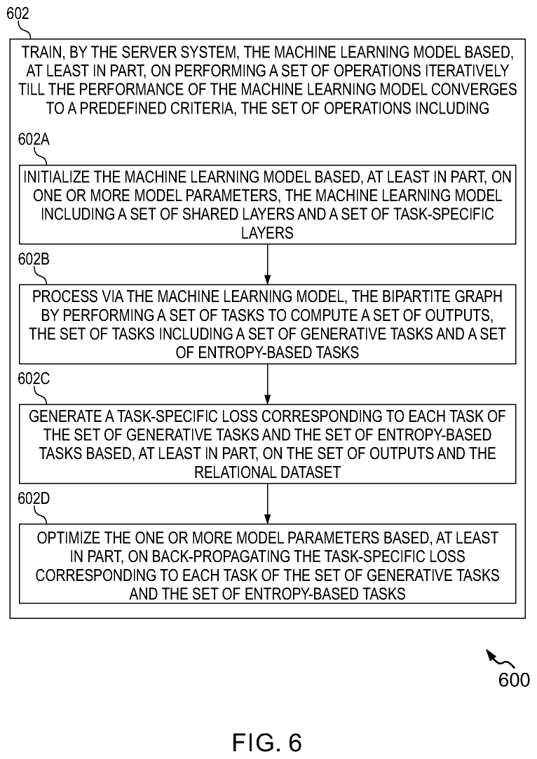

FIG. 6 illustrates a process flow diagram depicting a method 600 for training a machine learning model such as machine learning model 230, in accordance with an embodiment of the present disclosure. The method 600 depicted in the flow diagram may be executed by, for example, the server system 200. The sequence of operations of the method 600 may not be necessarily executed in the same order as they are presented. Further, one or more operations may be grouped and performed in the form of a single step, or one operation may have several sub-steps that may be performed in parallel or in a sequential manner. Operations of the method 600, and combinations of operations in the method 600 may be implemented by, for example, hardware, firmware, a processor, circuitry, and/or a different device associated with the execution of software that includes one or more computer program instructions. The plurality of operations is depicted in the process flow of the method 600. The process flow starts at operation 602.

At 602, the method 600 includes training, by a server system such as server system 200, the machine learning model 230 based, at least in part, on performing a set of operations iteratively till the performance of the machine learning model converges to a predefined criteria. The set of operations may include 602A-602D given below.

At 602A, the method 600 includes initializing the machine learning model 230 based, at least in part, on one or more model parameters. Herein, the machine learning model 230 may include a set of shared layers and a set of task-specific layers.

At 602B, the method 600 includes processing via the machine learning model, the bipartite graph by performing a set of tasks to compute a set of outputs. In an example, the set of tasks may include a set of generative tasks and a set of entropy-based tasks.

At 602C, the method 600 includes generating a task-specific loss corresponding to each task of the set of generative tasks and the set of entropy-based tasks based, at least in part, on the set of outputs and the relational dataset.

At 602D, the method 600 includes optimizing the one or more model parameters based, at least in part, on back-propagating the task-specific loss corresponding to each task of the set of generative tasks and the set of entropy-based tasks.

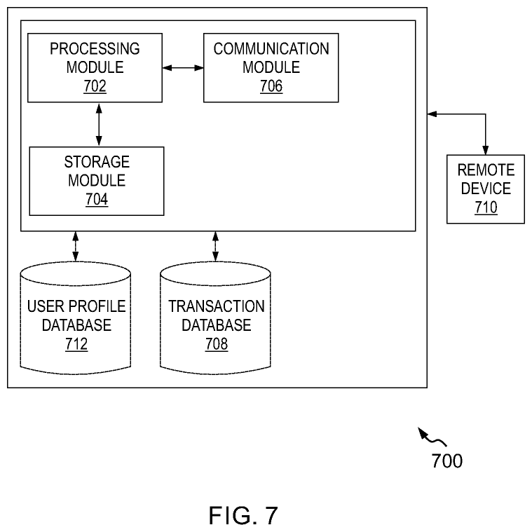

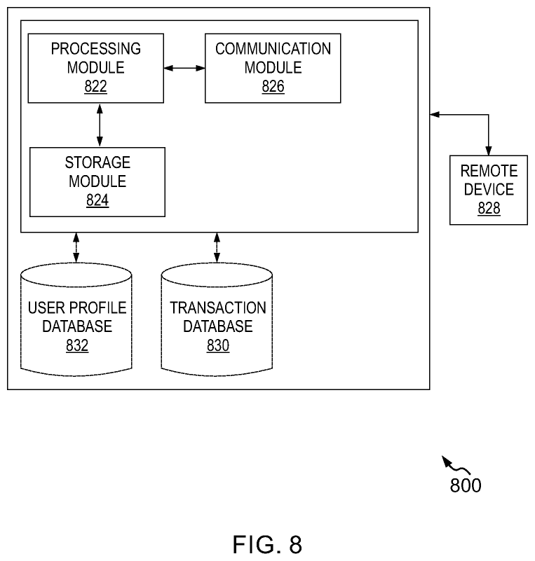

FIG. 7 illustrates a simplified block diagram of the acquirer server 700, in accordance with an embodiment of the present disclosure. The acquirer server 700 is an example of the acquirer server 108(1) of the plurality of acquirer servers 108 of FIG. 1. The acquirer server 700 is associated with an acquirer bank/acquirer, in which a merchant may have an account, which provides a payment card. The acquirer server 700 includes a processing module 702 operatively coupled to a storage module 704 and a communication module 706. The components of the acquirer server 700 provided herein may not be exhaustive and the acquirer server 700 may include more or fewer components than those depicted in FIG. 7. Further, two or more components may be embodied in one single component, and/or one component may be configured using multiple sub-components to achieve the desired functionalities. Some components of the acquirer server 700 may be configured using hardware elements, software elements, firmware elements, and/or a combination thereof.

The storage module 704 is configured to store machine-executable instructions to be accessed by the processing module 702. Additionally, the storage module 704 stores information related to, the contact information of the merchant, bank account number, availability of funds in the account, payment card details, transaction details, and/or the like. Further, the storage module 704 is configured to store payment transactions.

In one embodiment, the acquirer server 700 is configured to store profile data (e.g., an account balance, a credit line, details of the cardholders 104, account identification information, and a payment card number) in a transaction database 708. The details of the cardholders 104 may include, but are not limited to, name, age, gender, physical attributes, location, registered contact number, family information, alternate contact number, registered e-mail address, etc.

The processing module 702 is configured to communicate with one or more remote devices such as a remote device 710 using the communication module 706 over a network such as the network 116 of FIG. 1. The examples of the remote device 710 include the server system 102, the payment server 114, the plurality of issuer servers 110, or other computing systems of the acquirer server 700, and the like. The communication module 706 is capable of facilitating such operative communication with the remote devices and cloud servers using Application Program Interface (API) calls. The communication module 706 is configured to receive a payment transaction request performed by the cardholders 104 via the network 116. The processing module 702 receives payment card information, a payment transaction amount, customer information, and merchant information from the remote device 710 (i.e., the payment server 114). The acquirer server 700 includes a user profile database 712 and the transaction database 708 for storing transaction data. The user profile database 712 may include information of cardholders. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular user, transaction location information, external data sources, and other internal data to evaluate each transaction.

FIG. 8 illustrates a simplified block diagram of the issuer server 800, in accordance with an embodiment of the present disclosure. The issuer server 800 is an example of the issuer server 110(1) of the plurality of issuer servers 110 of FIG. 1. The issuer server 800 is associated with an issuer bank/issuer, in which an account holder (e.g., the plurality of cardholders 104(1)-104(N)) may have an account, which provides a payment card (e.g., the payment cards 118(1)-118(N)). The issuer server 800 includes a processing module 802 operatively coupled to a storage module 804 and a communication module 806. The components of the issuer server 800 provided herein may not be exhaustive and the issuer server 800 may include more or fewer components than those depicted in FIG. 8. Further, two or more components may be embodied in one single component, and/or one component may be configured using multiple sub-components to achieve the desired functionalities. Some components of the issuer server 800 may be configured using hardware elements, software elements, firmware elements, and/or a combination thereof.

The storage module 804 is configured to store machine-executable instructions to be accessed by the processing module 802. Additionally, the storage module 804 stores information related to, the contact information of the cardholders (e.g., the plurality of cardholders 104(1)-104(N)), a bank account number, availability of funds in the account, payment card details, transaction details, payment account details, and/or the like. Further, the storage module 804 is configured to store payment transactions.

In one embodiment, the issuer server 800 is configured to store profile data (e.g., an account balance, a credit line, details of the cardholders, account identification information, payment card number, etc.) in a database. The details of the cardholders may include, but are not limited to, name, age, gender, physical attributes, location, registered contact number, family information, alternate contact number, registered e-mail address, or the like of the cardholders, etc.

The processing module 802 is configured to communicate with one or more remote devices such as a remote device 808 using the communication module 806 over a network such as the network 116 of FIG. 1. Examples of the remote device 808 include the server system 200, the payment server 114, the acquirer server 108 or other computing systems of the issuer server 800. The communication module 806 is capable of facilitating such operative communication with the remote devices and cloud servers using API calls. The communication module 806 is configured to receive a payment transaction request performed by an account holder (e.g., the cardholder 104(1)) via the network 116. The processing module 802 receives payment card information, a payment transaction amount, customer information, and merchant information from the remote device 808 (e.g., the payment server 114). The issuer server 800 includes a transaction database 810 for storing transaction data. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular account holder, transaction location information, external data sources, and other internal data to evaluate each transaction. The issuer server 800 includes a user profile database 812 storing user profiles associated with the plurality of account holders.

The user profile data may include an account balance, a credit line, details of the account holders, account identification information, payment card number, or the like. The details of the account holders (e.g., the plurality of cardholders 104(1)-104(N)) may include, but are not limited to, name, age, gender, physical attributes, location, registered contact number, family information, alternate contact number, registered e-mail address, or the like of the cardholders 104.

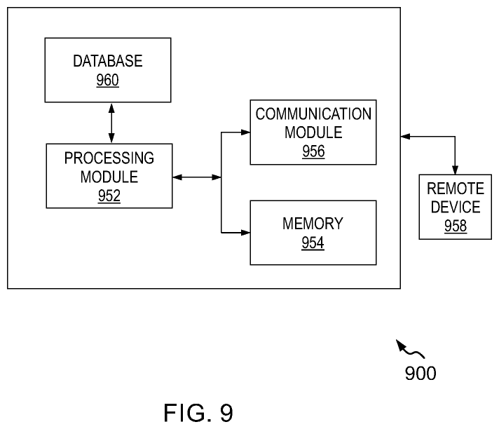

FIG. 9 illustrates a simplified block diagram of the payment server 900, in accordance with an embodiment of the present disclosure. The payment server 900 is an example of the payment server 114 of FIG. 1. The payment server 900 and the server system 200 may use the payment network 112 as a payment interchange network. Examples of payment interchange networks include, but are not limited to, Mastercard®; payment system interchange network.

The payment server 900 includes a processing system 902 configured to extract programming instructions from a memory 904 to provide various features of the present disclosure. The components of the payment server 900 provided herein may not be exhaustive and the payment server 900 may include more or fewer components than that depicted in FIG. 9. Further, two or more components may be embodied in one single component, and/or one component may be configured using multiple sub-components to achieve the desired functionalities. Some components of the payment server 900 may be configured using hardware elements, software elements, firmware elements, and/or a combination thereof.

Via a communication interface 906, the processing system 902 receives a request from a remote device 908, such as the issuer server 110, the acquirer server 108, or the server system 102. The request may be a request for conducting the payment transaction. The communication may be achieved through API calls, without loss of generality. The payment server 900 includes a database 910. The database 910 also includes transaction processing data such as issuer ID, country code, acquirer ID, and Merchant Identifier (MID), among others.

When the payment server 900 receives a payment transaction request from the acquirer server 108 or a payment terminal (e.g., IoT device), the payment server 900 may route the payment transaction request to an issuer server (e.g., the issuer server 110(1)). The database 910 stores transaction identifiers for identifying transaction details such as transaction amount, IoT device details, acquirer account information, transaction records, merchant account information, and the like.

In one example embodiment, the acquirer server 108(1) is configured to send an authorization request message to the payment server 900. The authorization request message includes, but is not limited to, the payment transaction request.

The processing system 902 further sends the payment transaction request to the issuer server 110(1) for facilitating the payment transactions from the remote device 908. The processing system 902 is further configured to notify the remote device 908 of the transaction status in the form of an authorization response message via the communication interface 906. The authorization response message includes, but is not limited to, a payment transaction response received from the issuer server 110(1). Alternatively, in one embodiment, the processing system 902 is configured to send an authorization response message for declining the payment transaction request, via the communication interface 906, to the acquirer server 108(1). In one embodiment, the processing system 902 executes similar operations performed by the server system 200, however, for the sake of brevity, these operations are not explained herein.

The disclosed method with reference to FIG. 5-6, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means include, for example, the Internet, the World Wide Web (WWW), an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example. Application Specific Integrated Circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause the processor or the computer to perform one or more operations. A computer-readable medium storing, embodying, or encoded with a computer program, or similar language, may be embodied as a tangible data storage device storing one or more software programs that are configured to cause the processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable (CD-R), compact disc rewritable (CD-R/W), Digital Versatile Disc (DVD), BLU-RAY® Disc (BD), and semiconductor memories (such as mask ROM, programmable ROM (PROM), (erasable PROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based on these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
accessing, by a server system, a bipartite graph from a database associated with the server system, the bipartite graph comprising a first set of nodes and a second set of nodes, wherein a set of edges exist between the first set of nodes and the second set of nodes, each node of the first set of nodes and the second set of nodes corresponding to a set of features and each edge indicating information related to a relationship between two distinct nodes in the bipartite graph; and
performing, by the server system, for each node of the first set of nodes and the second set of nodes in the bipartite graph:
identifying a natural neighbor node, the natural neighbor node being a two-hop neighbor node from the each node,
generating a temporary representation for a one-hop neighbor node based, at least in part, on the set of features corresponding to the one-hop neighbor node,
generating a temporary neighbor node based, at least in part, on the temporary representation for the one-hop neighbor node,
generating an augmented neighborhood based, at least in part, on the natural node and the temporary neighbor node, and
determining via a machine learning model, a task-agnostic representation for the each node based, at least in part, on the augmented neighborhood.

2. The computer-implemented method as claimed in claim 1, further comprising:
accessing, by the server system, a relational dataset from the database, the relational dataset comprising information related to a plurality of first entities, a plurality of second entities, and a relationship between the plurality of first entities and the plurality of second entities;
generating, by the server system, a first set of features for each of the plurality of first entities and a second set of features for each of the plurality of second entities based, at least in part, on the relational dataset; and
generating, by the server system, the bipartite graph based, at least in part, on the relational dataset, the first set of features, and the second set of features, the bipartite graph comprising the first set of nodes corresponding to the plurality of first entities and the second set of nodes corresponding to the plurality of second entities, wherein each of the first set of nodes and each of the second set of nodes is connected by an edge.

3. The computer-implemented method as claimed in claim 2, wherein the plurality of first entities is at least one of a plurality of cardholders, and a plurality of issuers, and wherein, the plurality of second entities is at least one of a plurality of merchants and a plurality of acquirers.

4. The computer-implemented method as claimed in claim 1, further comprising:
training, by the server system, the machine learning model based, at least in part, on performing a set of operations iteratively till the performance of the machine learning model converges to a predefined criteria, the set of operations comprising:
initializing the machine learning model based, at least in part, on one or more model parameters, the machine learning model comprising a set of shared layers and a set of task-specific layers,
processing via the machine learning model, the bipartite graph by performing a set of tasks to compute a set of outputs, the set of tasks comprising a set of generative tasks and a set of entropy-based tasks,
generating a task-specific loss corresponding to each task of the set of generative tasks and the set of entropy-based tasks based, at least in part, on the set of outputs and the relational dataset, and
optimizing the one or more model parameters based, at least in part, on back-propagating the task-specific loss corresponding to each task of the set of generative tasks and the set of entropy-based tasks.

5. The computer-implemented method as claimed in claim 4, wherein training the machine learning model, further comprises:
computing, by the server system, a task-specific activation probability for each task of the set of tasks;
performing, by the server system, one of:
scheduling one or more tasks from the set of tasks to activate based, at least in part, on the task-specific activation probability computed for the corresponding task being lower than a predefined threshold, and
scheduling the one or more tasks from the set of tasks to deactivate based, at least in part, on the task-specific activation probability computed for the corresponding task being at least equal to the predefined threshold.

6. The computer-implemented method as claimed in claim 4, wherein processing the bipartite graph by performing the set of tasks, further comprises:
processing via the machine learning model, the bipartite graph by performing the set of generative tasks, the set of generative tasks comprising at least a feature reconstruction task,
masking a subset of features from the set of features corresponding to each node of a subset of nodes of the bipartite graph,
predicting via the machine learning model, the subset of features corresponding to the each node based, at least in part, on the remaining features from the set of features corresponding to the each node,
computing a feature reconstruction loss for the subset of nodes based, at least in part, on the predicted subset of features and the subset of features, the feature reconstruction loss being the task-specific loss corresponding to the feature reconstruction task of the set of generative tasks, and
fine-tuning the one or more model parameters based, at least in part, on back-propagating the feature reconstruction loss.

7. The computer-implemented method as claimed in claim 4, wherein processing the bipartite graph by performing the set of tasks, further comprises:
processing via the machine learning model, the bipartite graph by performing the set of generative tasks, the set of generative tasks comprising at least a topological reconstruction task,
masking a subset of edges from the set of edges associated with a subset of nodes of the bipartite graph,
predicting via the machine learning model, the subset of edges associated with a subset of nodes of the bipartite graph based, at least in part, on the remaining edges from the set of edges,
computing a topological reconstruction loss for the subset of nodes based, at least in part, on the predicted subset of edges and the subset of edges, the topological reconstruction loss being the task-specific loss corresponding to the topological reconstruction task of the set of generative tasks, and
fine-tuning the one or more model parameters based, at least in part, on back-propagating the topological reconstruction loss.

8. The computer-implemented method as claimed in claim 4, wherein processing the bipartite graph by performing the set of tasks, further comprises:
processing via the machine learning model, the bipartite graph by performing the set of entropy-based tasks, the set of entropy-based tasks comprising at least a contrastive learning task,
computing via the machine learning model, an actual representation for the each node based, at least in part, on the set of features corresponding to the each node,
generating a neighbor node representation for the one-hop neighbor node of each node of a subset of nodes of the bipartite graph based, at least in part, on the set of features corresponding to the one-hop neighbor node,
predicting via the machine learning model, a predicted representation for the each node based, at least in part, on the neighbor node representation,
computing a contrastive loss for the each node based, at least in part, on the predicted representation and the actual representation, the contrastive loss being the task-specific loss corresponding to the contrastive learning task of the set of entropy-based tasks, and
fine-tuning the one or more model parameters based, at least in part, on back-propagating the contrastive loss.

9. The computer-implemented method as claimed in claim 4, wherein processing the bipartite graph by performing the set of tasks, further comprises:
processing via the machine learning model, the bipartite graph by performing the set of entropy-based tasks, the set of entropy-based tasks comprising at least a mutual information maximization for edge-graph task,
computing via the machine learning model, an edge representation for an edge of the set of edges based, at least in part, on the information related to a relationship between two distinct nodes connected by the edge,
computing via the machine learning model, a graph representation for the bipartite graph based, at least in part, on the set of features corresponding to each node of the bipartite graph,
computing an edge-graph loss for the edge based, at least in part, on the edge representation and the graph representation, the edge-graph loss being the task-specific loss corresponding to the mutual information maximization for edge-graph task of the set of entropy-based tasks, and
fine-tuning the one or more model parameters based, at least in part, on back-propagating the edge-graph loss.

10. The computer-implemented method as claimed in claim 4, wherein processing the bipartite graph by performing the set of tasks, further comprises:
processing via the machine learning model, the bipartite graph by performing the set of entropy-based tasks, the set of entropy-based tasks comprising at least a mutual information maximization for sub-graph-graph task,
extracting a sub-graph from the bipartite graph based, at least in part, on a predefined set of rules,
computing via the machine learning model, a sub-graph representation for the sub-graph based, at least in part, on the set of features corresponding to each node of the sub-graph,
computing via the machine learning model, a graph representation for the bipartite graph based, at least in part, on the set of features corresponding to each node of the bipartite graph,
computing a sub-graph-graph loss for the sub-graph based, at least in part, on the sub-graph representation and the graph representation, the sub-graph-graph loss being the task-specific loss corresponding to the mutual information maximization for sub-graph-graph task of the set of entropy-based tasks, and
fine-tuning the one or more model parameters based, at least in part, on back-propagating the sub-graph-graph loss.

11. The computer-implemented method as claimed in claim 1, wherein the machine learning model is a Multi-Task Bipartite Graph Neural Network (MultiBipGNN) based machine learning model.

12. A server system, comprising:
a memory configured to store instructions;
a communication interface; and
a processor in communication with the memory and the communication interface, the processor configured to execute the instructions stored in the memory and thereby cause the server system to perform at least in part to:
access a bipartite graph from a database associated with the server system, the bipartite graph comprising a first set of nodes and a second set of nodes, wherein a set of edges exist between the first set of nodes and the second set of nodes, each node of the first set of nodes and the second set of nodes corresponding to a set of features and each edge indicating information related to a relationship between two distinct nodes in the bipartite graph; and
perform for each node of the first set of nodes and the second set of nodes in the bipartite graph:
identifying a natural neighbor node, the natural neighbor node being a two-hop neighbor node from the each node,
generating a temporary representation for a one-hop neighbor node based, at least in part, on the set of features corresponding to the one-hop neighbor node,
generating a temporary neighbor node based, at least in part, on the temporary representation for the one-hop neighbor node,
generating an augmented neighborhood based, at least in part, on the natural node and the temporary neighbor node, and
determining via a machine learning model, a task-agnostic representation for the each node based, at least in part, on the augmented neighborhood.

13. The server system as claimed in claim 12, wherein the server system is further caused, at least in part, to:
access a relational dataset from the database, the relational dataset comprising information related to a plurality of first entities, a plurality of second entities, and a relationship between the plurality of first entities and the plurality of second entities;
generate a first set of features for each of the plurality of first entities and a second set of features for each of the plurality of second entities based, at least in part, on the relational dataset; and
generate the bipartite graph based, at least in part, on the relational dataset, the first set of features, and the second set of features, the bipartite graph comprising the first set of nodes corresponding to the plurality of first entities and the second set of nodes corresponding to the plurality of second entities, wherein each of the first set of nodes and each of the second set of nodes is connected by an edge.

14. The server system as claimed in claim 13, wherein for training the machine learning model the server system is further caused, at least in part, to:
compute a task-specific activation probability for each task of the set of tasks;
perform one of:
scheduling one or more tasks from the set of tasks to activate based, at least in part, on the task-specific activation probability computed for the corresponding task being lower than a predefined threshold, and
scheduling the one or more tasks from the set of tasks to deactivate based, at least in part, on the task-specific activation probability computed for the corresponding task being at least equal to the predefined threshold.

15. The server system as claimed in claim 13, wherein for processing the bipartite graph by performing the set of tasks, the server system is further caused, at least in part, to:
process via the machine learning model, the bipartite graph by performing the set of generative tasks, the set of generative tasks comprising at least a feature reconstruction task,
mask a subset of features from the set of features corresponding to each node of a subset of nodes of the bipartite graph,
predict via the machine learning model, the subset of features corresponding to the each node based, at least in part, on the remaining features from the set of features corresponding to the each node,
compute a feature reconstruction loss for the subset of nodes based, at least in part, on the predicted subset of features and the subset of features, the feature reconstruction loss being the task-specific loss corresponding to the feature reconstruction task of the set of generative tasks, and
fine-tune the one or more model parameters based, at least in part, on back-propagating the feature reconstruction loss.

16. The server system as claimed in claim 13, wherein for processing the bipartite graph by performing the set of tasks, the server system is further caused, at least in part, to:
process via the machine learning model, the bipartite graph by performing the set of generative tasks, the set of generative tasks comprising at least a topological reconstruction task,
mask a subset of edges from the set of edges associated with a subset of nodes of the bipartite graph,
predict via the machine learning model, the subset of edges associated with a subset of nodes of the bipartite graph based, at least in part, on the remaining edges from the set of edges,
compute a topological reconstruction loss for the subset of nodes based, at least in part, on the predicted subset of edges and the subset of edges, the topological reconstruction loss being the task-specific loss corresponding to the topological reconstruction task of the set of generative tasks, and
fine-tune the one or more model parameters based, at least in part, on back-propagating the topological reconstruction loss.

17. The server system as claimed in claim 13, wherein for processing the bipartite graph by performing the set of tasks, the server system is further caused, at least in part, to:
process via the machine learning model, the bipartite graph by performing the set of entropy-based tasks, the set of entropy-based tasks comprising at least a contrastive learning task,
compute via the machine learning model, an actual representation for the each node based, at least in part, on the set of features corresponding to the each node,
generate a neighbor node representation for the one-hop neighbor node of each node of a subset of nodes of the bipartite graph based, at least in part, on the set of features corresponding to the one-hop neighbor node,
predict via the machine learning model, a predicted representation for the each node based, at least in part, on the neighbor node representation,
compute a contrastive loss for the each node based, at least in part, on the predicted representation and the actual representation, the contrastive loss being the task-specific loss corresponding to the contrastive learning task of the set of entropy-based tasks, and
fine-tune the one or more model parameters based, at least in part, on back-propagating the contrastive loss.

18. The server system as claimed in claim 13, wherein for processing the bipartite graph by performing the set of tasks, the server system is further caused, at least in part, to:
process via the machine learning model, the bipartite graph by performing the set of entropy-based tasks, the set of entropy-based tasks comprising at least a mutual information maximization for edge-graph task,
compute via the machine learning model, an edge representation for an edge of the set of edges based, at least in part, on the information related to a relationship between two distinct nodes connected by the edge,
compute via the machine learning model, a graph representation for the bipartite graph based, at least in part, on the set of features corresponding to each node of the bipartite graph,
compute an edge-graph loss for the edge based, at least in part, on the edge representation and the graph representation, the edge-graph loss being the task-specific loss corresponding to the mutual information maximization for edge-graph task of the set of entropy-based tasks, and
fine-tune the one or more model parameters based, at least in part, on back-propagating the edge-graph loss.

19. The server system as claimed in claim 13, wherein for processing the bipartite graph by performing the set of tasks, the server system is further caused, at least in part, to:
process via the machine learning model, the bipartite graph by performing the set of entropy-based tasks, the set of entropy-based tasks comprising at least a mutual information maximization for sub-graph-graph task,
extract a sub-graph from the bipartite graph based, at least in part, on a predefined set of rules,
compute via the machine learning model, a sub-graph representation for the sub-graph based, at least in part, on the set of features corresponding to each node of the sub-graph,
compute via the machine learning model, a graph representation for the bipartite graph based, at least in part, on the set of features corresponding to each node of the bipartite graph,
compute a sub-graph-graph loss for the sub-graph based, at least in part, on the sub-graph representation and the graph representation, the sub-graph-graph loss being the task-specific loss corresponding to the mutual information maximization for sub-graph-graph task of the set of entropy-based tasks, and
fine-tune the one or more model parameters based, at least in part, on back-propagating the sub-graph-graph loss.

20. A non-transitory computer-readable storage medium comprising computer-executable instructions that, when executed by at least a processor of a server system, cause the server system to perform a method comprising:
accessing a bipartite graph from a database associated with the server system, the bipartite graph comprising a first set of nodes and a second set of nodes, wherein a set of edges exist between the first set of nodes and the second set of nodes, each node of the first set of nodes and the second set of nodes corresponding to a set of features and each edge indicating information related to a relationship between two distinct nodes in the bipartite graph; and
performing for each node of the first set of nodes and the second set of nodes in the bipartite graph:
identifying a natural neighbor node, the natural neighbor node being a two-hop neighbor node from the each node,
generating a temporary representation for a one-hop neighbor node based, at least in part, on the set of features corresponding to the one-hop neighbor node,
generating a temporary neighbor node based, at least in part, on the temporary representation for the one-hop neighbor node,
generating an augmented neighborhood based, at least in part, on the natural node and the temporary neighbor node, and
determining via a machine learning model, a task-agnostic representation for the each node based, at least in part, on the augmented neighborhood.
